(19) United States
(12) Patent Application Publication
(10) Pub. No.: US 2023/0344589 A1
(43) Pub. Date: Oct. 26, 2023

(54) SRS Spatial Relation to DL PRS Resource Set

(71) Applicant: Telefonaktiebolaget LM Ericsson (publ), Stockholm (SE)

(72) Inventors: Ritesh Shreevastav, Upplands Väsby (SE); Helka-Liina Määttänen, Helsinki (FI); Håkan Palm, Växjö (SE); Florent Munier, Västra Frölunda (SE)

(21) Appl. No.: 17/797,194

(22) PCT Filed: Jan. 13, 2021
(86) PCT No.: PCT/SE2021/050017

§ 371 Date: Aug. 3, 2022

Related U.S. Application Data
(60) Provisional application No. 62/971,676, filed on Feb. 7, 2020.
(60) Provisional application No. 62/972,409, filed on Feb. 10, 2020.

(51) Int. Cl. H04L 5/00

(52) U.S. Cl. CPC H04L 5/0051; H04L 5/0091

(57) ABSTRACT

Embodiments described herein provide methods and apparatuses to provide a Medium Access Control, MAC, Control Element, CE. A method in a wireless device comprises receiving a Medium Access Control, MAC, Control Element, CE, wherein the MAC CE comprises information identifying a spatial relation for positioning between a downlink reference signal that is to be received by the wireless device, and an uplink sounding reference signal, SRS, that is to be transmitted by the wireless device.

### TECHNICAL FIELD

Embodiments described herein relate to methods and apparatuses for providing a Medium Access Control, MAC, Control Element, CE.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

This relates to a MAC CE Design for SRS spatial relation to DL PRS Resource set And for Neighbor Cell/TRP Signaling.

NR Positioning

Positioning has been a topic in LTE standardization since 3GPP Release 9. The primary objective is to fulfill regulatory requirements for emergency call positioning. Positioning in NR is proposed to be supported by the architecture shown in FIG. 1. FIG. 1 illustrates NG-RAN Rel-15 LCSA Protocols. The Location Management Function, LMF, is the location node in NR. There are also interactions between the location node and the gNodeB via the NRPPa protocol. The interactions between the gNodeB and the device is supported via the Radio Resource Control (RRC) protocol.

Note 1: The gNB and ng-eNB may not always both be present.
Note 2: When both the gNB and ng-eNB are present, the NG-C interface is only present for one of them.
In the legacy LTE standards, the following techniques are supported:
Enhanced Cell ID. Essentially cell ID information to associate the device to the serving area of a serving cell, and then additional information to determine a finer granularity position.
Assisted GNSS. GNSS information retrieved by the device, supported by assistance information provided to the device from E-SMLC
OTDOA (Observed Time Difference of Arrival). The device estimates the time difference of reference signals from different base stations and sends to the E-SMLC for multi-lateration.
UTDOA (Uplink TDOA). The device is requested to transmit a specific waveform that is detected by multiple location measurement units (e.g. an eNB) at known positions. These measurements are forwarded to E-SMLC for multilateration
   The NR positioning for Rel.16, based on the 3GPP NR radio-technology, is uniquely positioned to provide added value in terms of enhanced location capabilities. The operation in low and high frequency bands (i.e. below and above 6 GHz) and utilization of massive antenna arrays provide additional degrees of freedom to substantially improve the positioning accuracy. The possibility to use wide signal bandwidth in low and especially in high bands brings new performance bounds for user location for well-known positioning techniques based OTDOA and UTDOA, Cell-ID or E-Cell-ID etc., utilizing timing measurements to locate a UE. The recent advances in massive antenna systems (massive MIMO) can provide additional degrees of freedom to enable a more accurate user location estimation by exploiting spatial and angular domains of the propagation channel in combination with time measurements.
   With 3GPP Release 9 Positioning Reference Signals (PRS) have been introduced for antenna port 6 as the Release 8 cell-specific reference signals are not sufficient for positioning. The simple reason is that the required high probability of detection could not be guaranteed. A neighbor cell with its synchronization signals (Primary-/Secondary Synchronization Signals) and reference signals is seen as detectable, when the Signal-to-Interference-and-Noise Ratio (SINR) is at least −6 dB. Simulations during standardization have however shown, that this can be only guaranteed for 70% of all cases for the 3rd best-detected cell, means 2nd best neighboring cell. This is not enough and it has been assumed an interference-free environment, which cannot be ensured in a real-world scenario. However, PRS have still some similarities with cell-specific reference signals as defined in 3GPP Release 8. It is a pseudo-random QPSK sequence that is being mapped in diagonal patterns with shifts in frequency and time to avoid collision with cell-specific reference signals and an overlap with the control channels (PDCCH).
   In NR Rel. 16 a WI is currently ongoing to specify extensive support for various positioning techniques. This is expected to include a NR Downlink Positioning Reference Signal (DL PRS) based on a staggered comb resource element pattern as well as extension of Rel-15 SRS configurations for improved positioning support. Support for RSTD measurements that may be used for OTDOA is expected as well as multi cell UE RX-TX time difference measurements that can be used for Round Trip Time (RTT) estimation. Rich reporting of multiple CIR/correlation peaks has been discussed as well as reporting of the strongest CIR/correlation peak.
   NR Rel. 16 will also support beamforming. The DL PRS is constructed as a DL PRS Resource set consisting of multiple DL PRS Resources. Each DL PRS Resource is transmitted over a separate beam. According to RAN1 decision an UL SRS can have a spatial relation to a DL PRS Resource as signaled through the combination of a DL PRS Resource set ID and a DL PRS Resource ID. The UE will then transmit the UL SRS using the same antenna panel as it uses to receive the corresponding DL PRS resource and using the same (reciprocal) beam as it uses to receive the DL PRS Resource.
   FIG. 2 illustrates the NR signaling flow between gNB, LMF and UE for configurations.
   Step 1: gNB provides DL PRS Info and supported UL SRS configurations (for aperiodic) (NRPPa)
   Step 2: LMF prepares and provides the configuration to UE for Beam sweep measurements based upon either SSB, CSI-RS or DL-PRS
   Step 3: LMF prepares the spatial relation; and optionally assigns a spatial relation ID and provides the spatial relation ID or configuration to the gNB (Request SRS configuration along with spatial relation info). The presence of spatial relation ID depends upon whether LMF would provide the spatial relation ID in LPP configuration to UE. In Positioning method such as MultiCell-RTT; LPP needs to provide DL PRS configuration in that case the spatial relation can be provided via LPP. In positioning method such as UL-TDOA, this is not essential, thus spatial relation ID may not be provided.
   Step 4: gNB configures the SRS Configuration; this may contain initial Spatial relationID or detailed spatial relation configurations
   Step 5: gNB provides the ack of configuration to the LMF
   Step 6: LMF provides LPP configuration to UE. Step 6 may happen prior or parallel to step 4/5
   Step 7: UE provides measurement result
   Step 8: Depending upon the result, LMF may decide to trigger step 9; that is trigger DCI for a new beam (UL SRS transmission) and/or MAC CE to update the spatial relation.

### Beamforming

The use of multi-antenna schemes in NR is a key concept. For NR, frequency ranges up to 100 GHz are considered. Currently, two NR frequency ranges are explicitly distinguished in 3GPP: frequency range FR1 (below 6 GHz) and frequency range FR2 (above 6 GHz). It is known that high-frequency radio communication above 6 GHz suffers from significant path loss and penetration loss. One solution to address this issue is to deploy large-scale antenna arrays to achieve high beamforming gain, which is a reasonable solution due to the small wavelength of high-frequency signal. Therefore MIMO schemes for NR are also called massive MIMO. Up to 64 beams are now supported for FR2. For sub-6 GHz communication, to obtain more beamforming and multiplexing gain by increasing the number of antenna elements is also a trend.
With massive MIMO, three approaches to beamforming have been discussed: analog, digital, and hybrid (a combination of the two). The analog beamforming would compensate high pathloss in NR scenarios, while digital precoding would provide additional performance gains similar to MIMO for sub-6 GHz necessary to achieve a reasonable coverage. The implementation complexity of analog beamforming is significantly less than digital precoding since it is in many implementations relies on simple phase shifters, but the drawbacks are its limitation in multi-direction flexibility (i.e., a single beam can be formed at a time and the beams are then switched in time domain), only wideband transmissions (i.e., not possible to transmit over a subband), unavoidable inaccuracies in the analog domain, etc. Digital beamforming (requiring costly converters to/from the digital domain from/to IF domain), used today in LTE, provides the best performance in terms of data rate and multiplexing capabilities (multiple beams over multiple subbands at a time can be formed), but at the same time it is challenging in terms of power consumption, integration, and cost; in addition to that the gains do not scale linearly with the number of transmit/receive units while the cost is growing rapidly. Supporting hybrid beamforming, to benefit from cost-efficient analog beamforming and high-capacity digital beamforming, is therefore desirable for NR. An example diagram for hybrid beamforming is shown in FIG. 3.
Beamforming can be on transmission beams and/or reception beams, network side or UE side.
Beamforming can be at the tx side and/or rx side; the basic principles are similar for tx and rx beamforming, except that the signal is not transmitted in the end via beams but being received with rx beamforming instead.

### Beam Sweeping

The analog beam of a subarray can be steered toward a single direction on each OFDM symbol, and hence the number of subarrays determines the number of beam directions and the corresponding coverage on each OFDM symbol. However, the number of beams to cover the whole serving area is typically larger than the number of subarrays, especially when the individual beam-width is narrow. Therefore, to cover the whole serving area, multiple transmissions with narrow beams differently steered in time domain are also likely to be needed. The provision of multiple narrow coverage beams for this purpose has been called “beam sweeping”. For analog and hybrid beamforming, the beam sweeping seems to be essential to provide the basic coverage in NR. For this purpose, multiple OFDM symbols, in which differently steered beams can be transmitted through subarrays, can be assigned and periodically transmitted.
The Rx beam sweeping is similar to Tx beam sweeping but at the receiver side, sweeping over Rx beams instead.
FIG. 4a illustrates beam sweeping on 2 subarrays
FIG. 4b illustrates beam sweeping on 3 subarrays.

### MAC Specification

Current MAC specification (38.321 v15.8.0)

### 6.1.3.17 SP SRS Activation/Deactivation MAC CE

The SP SRS Activation/Deactivation MAC CE is identified by a MAC subheader with LCID as specified in Table 6.2.1-1. It has a variable size with following fields:
A/D: This field indicates whether to activate or deactivate indicated SP SRS resource set. The field is set to 1 to indicate activation, otherwise it indicates deactivation;
SRS Resource Set's Cell ID: This field indicates the identity of the Serving Cell, which contains activated/deactivated SP SRS Resource Set. If the C field is set to 0, this field also indicates the identity of the Serving Cell which contains all resources indicated by the Resource IDi fields. The length of the field is 5 bits;
SRS Resource Set's BWP ID: This field indicates a UL BWP as the codepoint of the DCI bandwidth part indicator field as specified in TS 38.212 [9], which contains activated/deactivated SP SRS Resource Set. If the C field is set to 0, this field also indicates the identity of the BWP which contains all resources indicated by the Resource IDi fields. The length of the field is 2 bits;
C: This field indicates whether the octets containing Resource Serving Cell ID field(s) and Resource BWP ID field(s) are present. If this field is set to 1, the octets containing Resource Serving Cell ID field(s) and Resource BWP ID field(s) are present, otherwise they are not present;
SUL: This field indicates whether the MAC CE applies to the NUL carrier or SUL carrier configuration. This field is set to 1 to indicate that it applies to the SUL carrier configuration, and it is set to 0 to indicate that it applies to the NUL carrier configuration;
SP SRS Resource Set ID: This field indicates the SP SRS Resource Set ID identified by SRS-ResourceSetId as specified in TS 38.331 [5], which is to be activated or deactivated. The length of the field is 4 bits;
Fi: This field indicates the type of a resource used as a spatial relationship for SRS resource within SP SRS Resource Set indicated with SP SRS Resource Set ID field. F0 refers to the first SRS resource within the resource set, F1 to the second one and so on. The field is set to 1 to indicate NZP CSI-RS resource index is used, and it is set to 0 to indicate either SSB index or SRS resource index is used. The length of the field is 1 bit. This field is only present if MAC CE is used for activation, i.e. the A/D field is set to 1;
Resource IDi: This field contains an identifier of the resource used for spatial relationship derivation for SRS resource i. Resource ID0 refers to the first SRS resource within the resource set, Resource ID1 to the second one and so on. If Fi is set to 0, and the first bit of this field is set to 1, the remainder of this field contains SSB-Index as specified in TS 38.331 [5]. If Fi is set to 0, and the first bit of this field is set to 0, the remainder of this field contains SRS-ResourceId as specified in TS 38.331 [5]. The length of the field is 7 bits. This field is only present if MAC CE is used for activation, i.e. the A/D field is set to 1;
Resource Serving Cell IDi: This field indicates the identity of the Serving Cell on which the resource used for spatial relationship derivation for SRS resource i is located. The length of the field is 5 bits;
Resource BWP IDi: This field indicates a UL BWP as the codepoint of the DCI bandwidth part indicator field as specified in TS 38.212 [9], on which the resource used for spatial relationship derivation for SRS resource i is located. The length of the field is 2 bits;
R: Reserved bit, set to 0.
   FIG. 5 illustrates SP SRS Activation/Deactivation MAC CE

### SRS-Config

The IE SRS-Config is used to configure sounding reference signal transmissions. The configuration defines a list of SRS-Resources and a list of SRS-ResourceSets. Each resource set defines a set of SRS-Resources. The network triggers the transmission of the set of SRS-Resources using a configured aperiodicSRS-ResourceTrigger (L1 DCI).

### SRS-Config Information Element

-- ASN1START
-- TAG-SRS-CONFIG-START

| | |
|---|---|
| SRS-Config ::= | SEQUENCE { |

| | |
|---|---|
| srs-ResourceSetToReleaseList | SEQUENCE |
| (SIZE(1..maxNrofSRS-ResourceSets)) OF SRS-ResourceSetId | OPTIONAL, |

-- Need N

| | |
|---|---|
| srs-ResourceSetToAddModList | SEQUENCE |
| (SIZE(1..maxNrofSRS-ResourceSets)) OF SRS-ResourceSet | OPTIONAL, |

-- Need N

| | |
|---|---|
| srs-ResourceToReleaseList | SEQUENCE |
| (SIZE(1..maxNrofSRS-Resources)) OF SRS-ResourceId | OPTIONAL, |

-- Need N

| | |
|---|---|
| srs-ResourceToAddModList | SEQUENCE |
| (SIZE(1..maxNrofSRS-Resources)) OF SRS-Resource | OPTIONAL, |

-- Need N

| | |
|---|---|
| tcp-Accumulation | ENUMERATED {disabled} |

```
OPTIONAL, -- Need S
    . . . ,
  [ [
```

| | |
|---|---|
| srs-ResourceSetToReleaseList-r16 | SEQUENCE (SIZE(1..maxNrofSRS- |
| ResourceSets)) OF SRS-ResourceSetId-r16 | OPTIONAL, -- Need N |
| srs-ResourceSetToAddModList-r16 | SEQUENCE (SIZE(1..maxNrofSRS- |
| ResourceSets)) OF SRS-ResourceSet-r16 | OPTIONAL, -- Need N |
| srs-ResourceToReleaseList-r16 | SEQUENCE (SIZE(1..maxNrofSRS- |
| Resources)) OF SRS-ResourceId-r16 | OPTIONAL, -- Need N |
| srs-ResourceToAddModList-r16 | SEQUENCE (SIZE(1..maxNrofSRS- |
| Resources)) OF SRS-Resource-r16 | OPTIONAL -- Need N |

] ]
}

| | |
|---|---|
| SRS-ResourceSet ::= | SEQUENCE { |
| srs-ResourceSetId | SRS-ResourceSetId, |
| srs-ResourceIdList | SEQUENCE (SIZE(1--maxNrofSRS- |
| ResourcesPerSet)) OF SRS-ResourceId | OPTIONAL, -- Cond Setup |
| resourceType | CHOICE { |
| aperiodic | SEQUENCE { |

| | |
|---|---|
| aperiodicSRS-ResourceTrigger | INTEGER |

(1..maxNrofSRS-TriggerStates-1),

| | |
|---|---|
| csi-RS | NZP-CSI-RS- |
| ResourceID | OPTIONAL, -- Cond NonCodebook |
| slotOffset | INTEGER (1..32) |

```
OPTIONAL, -- Need S
                . . . ,
                [ [
```

| | |
|---|---|
| aperiodicSRS-ResourceTriggerList | SEQUENCE |

(SIZE(1..maxNrofSRS-TriggerStates-2))

OF

| | |
|---|---|
| INTEGER (1..maxNrofSRS-TriggerStates-1)) | OPTIONAL -- Need M |

```
                ] ]
          },
```

| | |
|---|---|
| semi-persistent | SEQUENCE { |
| associatedCSI-RS | NZP-CSI-RS- |
| ResourceId | OPTIONAL, -- Cond NonCodebook |

```
                . . .
          },
```

| | |
|---|---|
| periodic | SEQUENCE { |
| associatedCSI-RS | NZP-CSI-RS- |
| ResourceId | OPTIONAL, -- Cond NonCodebook |

```
                . . .
          }
    },
```

| | |
|---|---|
| usage | ENUMERATED {beamManagement, |

codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | CHOICE { |
| ssb-Index | SSB-Index |
| csi-RS-Index | NZP-CSI-RS-ResourceId |

}
OPTIONAL, -- Need M

| | |
|---|---|
| srs-PowerControlAdjustmentStates | ENUMERATED { sameAsFCi2, |
| separateClosedLoop} | OPTIONAL, -- Need S |

. . .
}

| | |
|---|---|
| SRS-ResourceSet-r16 ::= | SEQUENCE { |
| srs-ResourceSetId-r16 | SRS-ResourceSetId-r16 |

| | |
|---|---|
| srs-ResourceIdList-r16 | SEQUENCE |

| | |
|---|---|
| (SIZE(1..maxNrofSRS-ResourcesPerSet)) | OF SRS-ResourceId-r16 |

OPTIONAL, -- Cond Setup

| | |
|---|---|
| resourceType-r16 | CHOICE { |
| aperiodic-r16 | SEQUENCE { |

| | |
|---|---|
| aperiodicSRS-ResourceTriggerList-r16 | SEQUENCE |

(SIZE(1..maxNrofSRS-TriggerSTates-1))

OF

| | |
|---|---|
| (INTEGER (1..maxNrofSRS-TriggerStates-1) | OPTIONAL, -- Need M |
| slotOffset-r16 | INTEGER (1..32) |

```
OPTIONAL, -- Need S
                . . .
          },
```

| | |
|---|---|
| semi-persistent-r16 | SEQUENCE { |

```
                . . .
          },
```

| | |
|---|---|
| Periodic-r16 | SEQUENCE { |

```
                . . .
          }
    },
```

| | |
|---|---|
| alpha-r16 | Alpha |

OPTIONAL, -- Need S

| | |
|---|---|
| p0-r16 | INTEGER (−202..24), |

OPTIONAL, -- Cond Setup

| | |
|---|---|
| pathlossReferenceRS-r16 | CHOICE { |
| ssb-Index-16 | SSB-Index |
| csi-RS-Index-r16 | NZP-CSI-RS- |

ResourceId,

| | |
|---|---|
| ssb-r16 | SSB-InfoNcell-r16 |
| dl-PRS-r16 | DL-PRS-Info-r16 |

```
      }
OPTIONAL, -- Need M
    . . .
}
```

| | |
|---|---|
| SRS-ResourceSetId ::= | INTEGER (0..maxNrofSRS- |

ResourceSets-1)

| | |
|---|---|
| SRS-ResourceSetId-r16 ::= | INTEGER (0..maxNrofSRS- |

ResourceSets-1)

| | |
|---|---|
| SRS-Resource ::= | SEQUENCE { |
| srs-ResourceID | SRS-ResourceId, |
| nrofSRS-Ports | ENUMERATED {port1, ports2, |

ports4},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
          }
    },
```

| | |
|---|---|
| resourceMapping | SEQUENCE { |
| startPosition | INTEGER (0..5), |
| nrofSymbols | ENUMERATED {n1, n2 |

n4},

| | |
|---|---|
| repetitionFactor | ENUMERATED {n1, n2 |

n4}
},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
                . . .
          },
```

| | |
|---|---|
| semi-persistent | SEQUENCE { |

| | |
|---|---|
| periodicityAndOffset-sp | SRS- |

```
PeriodicityAndOffset,
                . . .
          },
```

| | |
|---|---|
| periodic | SEQUENCE { |

| | |
|---|---|
| periodicityAndOffset-p | SRS- |

```
PeriodicityAndOffset,
                . . .
          }
    },
```

| | |
|---|---|
| sequenceId | INTEGER (0..1023), |
| spatialRelationInfo | SRS-SpatialRelationInfo |

OPTIONAL, -- Need R
. . .
}

| | |
|---|---|
| SRS-Resource-r16 ::= | SEQUENCE { |
| srs-ResourceId-r16 | SRS-ResourceId-r16, |
| transmissionComb-r16 | CHOICE { |
| n2-r16 | SEQUENCE { |
| combOffset-n2-r16 | INTEGER (0..1), |
| cyclicShift-n2-r16 | INTEGER (0..7) |

},

| | |
|---|---|
| n4-r16 | SEQUENCE { |
| combOffset-n4-r16 | INTEGER (0..3), |
| cyclicShift-n4-r16 | INTEGER (0..11) |

},

| | |
|---|---|
| n8-r16 | SEQUENCE { |
| combOffset-n8-r16 | INTEGER (0..7), |
| cyclicShift-n8-r16 | INTEGER (0..5) |

```
          },
      . . .
    },
```

| | |
|---|---|
| resourceMapping-r16 | SEQUENCE { |
| startPosition-r16 | INTEGER (0..13) |
| nrofSymbols-r16 | ENUMERATED {n1, |

n2, n4, n8, n12}
},

| | |
|---|---|
| freqDomainShift-r16 | INTEGER (0..268), |
| freqHopping-r16 | SEQUENCE { |
| c-SRS-r16 | INTEGER (0..63) |

},

| | |
|---|---|
| groupOrSequenceHopping-r16 | ENUMERATED { neither, |

groupHopping, sequenceHopping },

| | |
|---|---|
| resourceType-r16 | CHOICE { |
| aperiodic-r16 | SEQUENCE { |

```
                . . .
          },
```

| | |
|---|---|
| semi-persistent-r16 | SEQUENCE { |

| | |
|---|---|
| periodicityAndOffset-sp-r16 | SRS- |

```
PeriodicityAndOffset-v16xy,
                . . .
          },
```

| | |
|---|---|
| periodic-r16 | SEQUENCE { |

| | |
|---|---|
| periodicityAndOffset-p-r16 | SRS- |

```
PeriodicityAndOffset-v16xy,
                . . .
          }
    },
```

| | |
|---|---|
| sequenceId-r16 | INTEGER (0..65535), |
| spatialRelation-r16 | SRS-SpatialRelationInfo- |

r16 OPTIONAL, -- Need R
. . .
}

| | |
|---|---|
| SRS-SpatialRelationInfo ::= | SEQUENCE { |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
          }
    }
}
```

| | |
|---|---|
| SRS-SpatialRelationInfo-r16 ::= | SEQUENCE { |
| servingCellId-r16 | ServCellIndex |

OPTIONAL, -- Need S

| | |
|---|---|
| referenceSignal-r16 | CHOICE { |
| ssb-Index-r16 | SSB-Index, |
| csi-RS-Index-r16 | NZP-CSI-RS- |

ResourceId,

| | |
|---|---|
| srs-SpatialRelation-16 | SEQUENCE { |
| resourceSelection-r16 | CHOICE { |
| type1-r16 | SRS-ResourceID |
| type2-r16 | SRS-ResourceID-r16 |

}

| | |
|---|---|
| uplinkBWP-r16 | BWP-Id |

},

| | |
|---|---|
| ssbNcell-r16 | SSB-InfoNcell-r16, |
| dl-PRS-r16 | DL-PRS-Info-r16 |

}
}

| | |
|---|---|
| SSB-Configuration-r16: := | SEQUENCE { |
| carrierFreq-r16 | ARFCN-ValueNR, |
| halfFrameIndex | ENUMERATED {zero, one}, |
| ssbSubcarrierSpacing-r16 | SubcarrierSpacing, |
| ssb-periodicity-r16 | ENUMERATED { ms5, ms10, ms20, |
| ms40, ms80, ms160, spare2,spare1 } | OPTIONAL, -- Need S |
| smtc-r16 | SSB-MTC OPTIONAL, |

-- Need S

| | |
|---|---|
| sfn-Offset-r16 | INTEGER (0..maxNumFFS), |
| sfn-SSB-Offset-r16 | INTEGER (0..15), |
| ss-PBCH-BlockPower-r16 | INTEGER (−60..50) OPTIONAL |

-- Cond Pathloss
}
SSB-InfoNcell-r16 ::= SEQUENCE {

| | |
|---|---|
| physicalCellId-r16 | PhysCellId, |
| ssb-IndexNcell-r16 | SSB-Index, |
| ssb-Configuration-r16 | SSB-Configuration-r16 |

OPTIONAL
}
DL-PRS-Info-r16 ::= SEQUENCE {

| | |
|---|---|
| trp-ID-r16 | INTEGER (0..maxNumFFS), --FFS on the |

value range

| | |
|---|---|
| dL-PRS-ResourceSetID-r16 | INTEGER (0..8), |
| dL-PRS-ResourceID-r16 | INTEGER (0..64) OPTIONAL - |

- Cond Pathloss
}

| | |
|---|---|
| SRS-ResourceID ::= | INTEGER (0..maxNrofSRS- |

Resources-1)

| | |
|---|---|
| SRS-ResourceId-r16 ::= | INTEGER (0..maxNrofSRS- |

Resources-1)

| | |
|---|---|
| SRS-PeriodicityAndOffset ::= | CHOICE { |
| sl1 | NULL, |
| sl2 | INTEGER(0..1), |
| sl4 | INTEGER(0..3), |
| sl5 | INTEGER(0..4), |
| sl8 | INTEGER(0..7), |
| sl10 | INTEGER(0..9), |
| sl16 | INTEGER(0..15), |
| sl20 | INTEGER(0..19), |
| sl32 | INTEGER(0..31), |
| sl40 | INTEGER(0..39), |
| sl64 | INTEGER(0..63), |
| sl80 | INTEGER(0..79), |
| sl160 | INTEGER(0..159), |
| sl320 | INTEGER(0..319), |
| sl640 | INTEGER(0..639), |
| sl1280 | INTEGER(0..1279), |
| sl2560 | INTEGER(0..2559), |
| } | |
| SRS-PeriodicityAndOffset-v16xy ::= | CHOICE { |
| sl1 | NULL, |
| sl2 | INTEGER(0..1), |
| sl4 | INTEGER(0..3), |
| sl5 | INTEGER(0..4), |
| sl8 | INTEGER(0..7), |
| sl10 | INTEGER(0..9), |
| sl16 | INTEGER(0..15), |
| sl20 | INTEGER(0..19), |
| sl32 | INTEGER(0..31), |
| sl40 | INTEGER(0..39), |
| sl64 | INTEGER(0..63), |
| sl80 | INTEGER(0..79), |
| sl160 | INTEGER(0..159), |
| sl320 | INTEGER(0..319), |
| sl640 | INTEGER(0..639), |
| sl1280 | INTEGER(0..1279), |
| sl2560 | INTEGER(0..2559), |
| sl5120 | INTEGER(0..5119), |
| sl10240 | INTEGER(0..10239), |
| sl40960 | INTEGER(0..40959), |
| sl81920 | INTEGER(0..81919), |

. . .
}
-- TAG-SRS-CONFIG-STOP
-- ASN1STOP

There currently exist certain challenge(s).

Currently spatial relation is only defined for serving cell with respect to SSB, CSI-RS or SRS. For Positioning, it is needed that the spatial relationship is also defined with respect to neighbor cells/TRPs. Further, DL-PRS should also be possible to be included as one option for defining the spatial relation.

The addition of new reference signal for spatial relation would require new signaling for MAC for activating/deactivating the SRS and indicating spatial relation to the SRS, or only updating the spatial relation to the SRS.

Certain aspects of the present disclosure and their embodiments may provide solutions to these or other challenges.

There are disclosed herein embodiments of a MAC CE defined such as to convey the new reference signal and neighbor cell related info for the spatial relations.

There are, proposed herein, various embodiments which address one or more of the issues disclosed herein.

Generally, embodiments disclose the signalling of a spatial relation between the Sounding Reference Signal (SRS) and a Downlink Positioning Reference Signal (DL PRS) or Synchronization System Block (SSB) or SRS.

Certain embodiments may provide one or more of the following technical advantage(s).

For example, in certain embodiments, it is possible to configure semi persistent SRS configuration for Positioning purpose. A new MAC Signaling may be used for conveying the new spatial relations with regards to the new reference signal and/or for the neighbor cells.

### SUMMARY

According to some embodiments there is provided a method performed by a wireless device. The method comprises receiving a Medium Access Control, MAC, Control Element, CE, wherein the MAC CE comprises information identifying a spatial relation for positioning between a downlink reference signal that is to be received by the wireless device, and an uplink sounding reference signal, SRS, that is to be transmitted by the wireless device.

According to some embodiments there is provided a wireless device. The wireless device comprises processing circuitry configured to perform the method as described above.

According to some embodiments there is provided a method performed by base station for configuring a wireless device. The method comprises transmitting a Medium Access Control, MAC, Control Element, CE, to the wireless device, wherein the MAC CE comprises information identifying a spatial relation for positioning between a downlink reference signal that is to be received by the wireless device, and an uplink sounding reference signal, SRS, that is to be transmitted by the wireless device.

According to some embodiments there is provided a base station. The base station comprises processing circuitry configured to perform the method as described above.

### BRIEF DESCRIPTION OF THE DRAWINGS

FIG. 1 illustrates NG-RAN Rel-15 LCSA Protocols;

FIG. 2 illustrates the NR signaling flow between gNB, LMF and UE for configurations;

FIG. 3 illustrates example diagram for hybrid beamforming;

FIG. 4a illustrates beam sweeping on 2 subarrays;

FIG. 4b illustrates beam sweeping on 3 subarrays;

FIG. 5 illustrates SP SRS Activation/Deactivation MAC CE;

FIG. 6 illustrates an example MAC CE;

FIG. 7 illustrates an example MAC CE;

FIG. 8 illustrates an example MAC CE;

FIG. 9 illustrates a wireless network in accordance with some embodiments;

FIG. 10 illustrates a User Equipment in accordance with some embodiments;

FIG. 11 illustrates a virtualization environment in accordance with some embodiments;

FIG. 12 illustrates a telecommunication network connected via an intermediate network to a host computer in accordance with some embodiments;

FIG. 13 illustrates a host computer communicating via a base station with a user equipment over a partially wireless connection in accordance with some embodiments.

FIG. 14 illustrates methods implemented in a communication system including a host computer, a base station and a user equipment in accordance with some embodiments;

FIG. 15 illustrates methods implemented in a communication system including a host computer, a base station and a user equipment in accordance with some embodiments;

FIG. 16 illustrates methods implemented in a communication system including a host computer, a base station and a user equipment in accordance with some embodiments;

FIG. 17 illustrates methods implemented in a communication system including a host computer, a base station and a user equipment in accordance with some embodiments;

FIG. 18 illustrates a method in accordance with some embodiments;

FIG. 19 illustrates a virtualization apparatus in accordance with some embodiments;

FIG. 20 illustrates a method in accordance with some embodiments;

FIG. 21 illustrates a virtualization apparatus in accordance with some embodiments;

FIG. 22 illustrates a method in accordance with some embodiments;

FIG. 23 illustrates a virtualization apparatus in accordance with some embodiments;

FIG. 24 illustrates a method in accordance with some embodiments;

FIG. 25 illustrates a virtualization apparatus in accordance with some embodiments

FIG. 26 illustrates a method in accordance with some embodiments;

FIG. 27 illustrates a virtualization apparatus in accordance with some embodiments

FIG. 28 illustrates a method in accordance with some embodiments;

FIG. 29 illustrates a virtualization apparatus in accordance with some embodiments

FIG. 30 illustrates a method in accordance with some embodiments;

FIG. 31 illustrates a virtualization apparatus in accordance with some embodiments;

FIG. 32 illustrates a method in accordance with some embodiments;

FIG. 33 illustrates a virtualization apparatus in accordance with some embodiments;

FIG. 34 illustrates a method in accordance with some embodiments;

FIG. 35 illustrates a virtualization apparatus in accordance with some embodiments;

FIG. 36 illustrates a method in accordance with some embodiments;

FIG. 37 illustrates a virtualization apparatus in accordance with some embodiments.

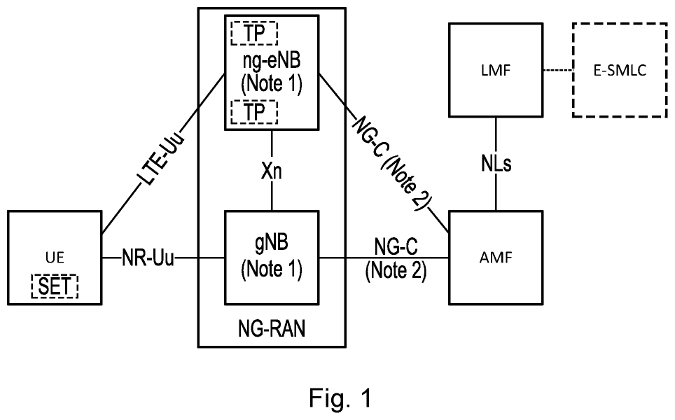

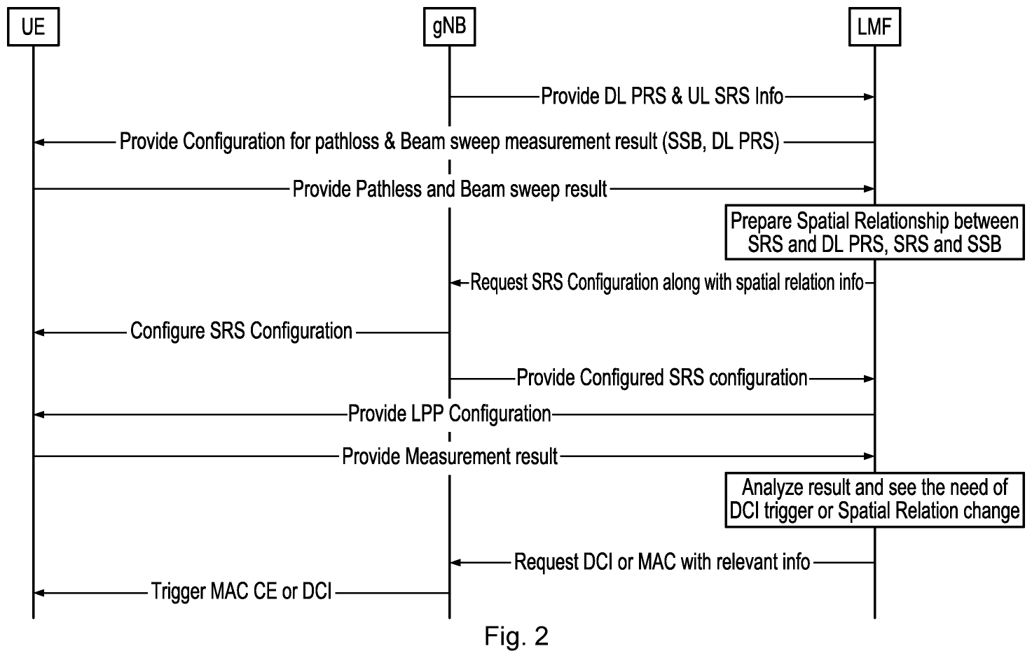

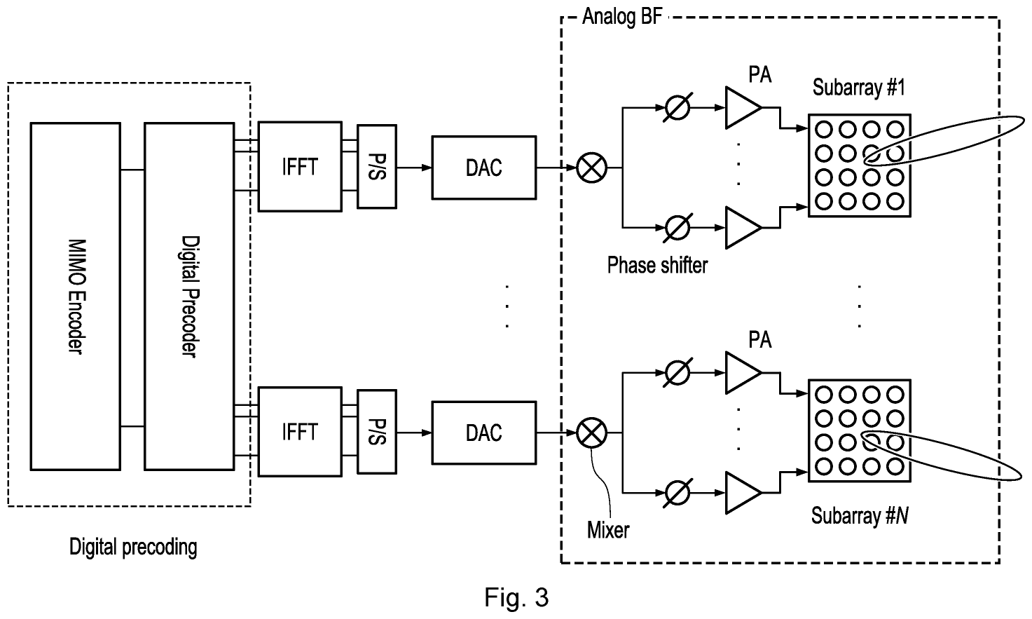

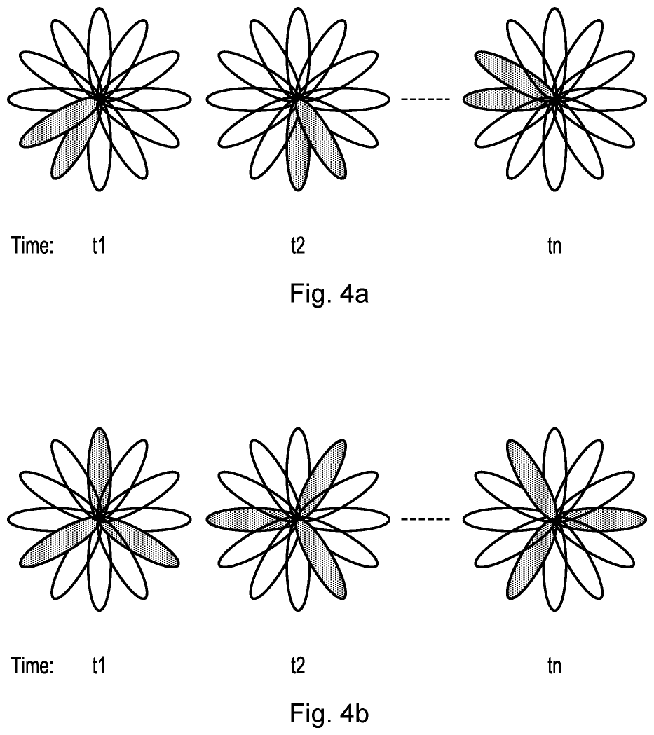

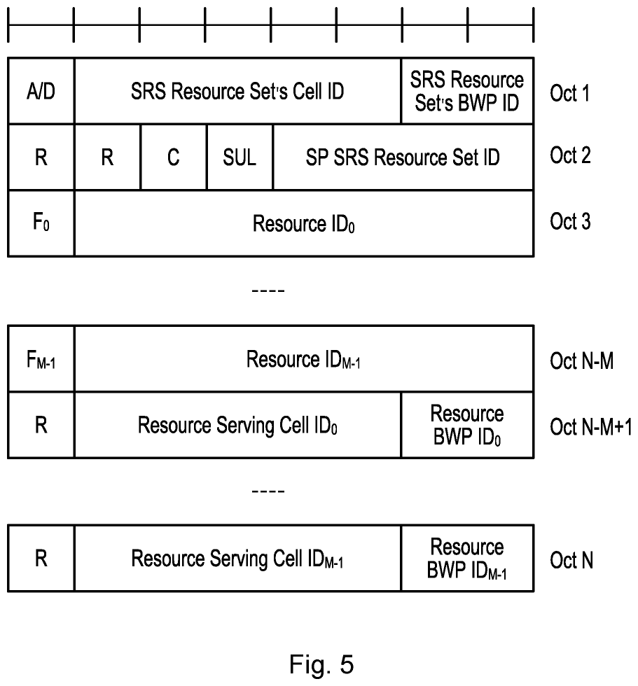

### DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Based upon the signaling procedure described above between the UE, the gNB and the LMF, various embodiments are presented below.

In one of the embodiments a new Logical Channel Identifier, LCID, is used for relaying the Positioning spatial relation and a new MAC payload corresponding to this new MAC CE subheader is defined.

A MAC CE may have variable payload size (octets); in one of the embodiments, the UE will know, depending upon the octet size, whether full spatial relation configuration is present or whether a spatial relation ID exists.

In one of the embodiments, depending upon the positioning method, LMF may decide to use the spatial relation ID or full configuration in the New Radio (NR) Positioning Protocol A (NRPPa).

In LTE, the Transmission Point (TP) ID is 12 bits long. In NR, it is possible to use the same 12 bit long TP ID as the Transmission and Reception Point (TRP) ID or further in NR, there may be hard limit on the number of TRPs, for example, there can be up to 4 Frequency layers that can be configured, and each Frequency layer can have a maximum of 64 TRP configurations. Thus, in total 256 TRPs which can be represented by 8 bits.

Further, RAN1 has agreed to have two different resource set ID per frequency layer per TRP (one for a wide beam sweep and another can be used to configure narrow beams); the resource set ID can be uniquely represented by a bit if frequency layer is known from RRC or LPP; for example, if bit is 0; it can imply Set ID1 and if it is 1, it can be set ID2.

If frequency layer is unknown, UE may not uniquely identify the resource set. In such case, 3 bits would be needed to represent the resource set (in total 8 resource sets). Each resource set may have 64 resource ID.

The main purpose of spatial relation is to assist the UE identifying the direction in which the UE should project it's UL beam. The direction can be obtained based upon resource set. There is as such no additional need of resource ID and this field could be optional.

### Detailed Embodiments Related to MAC CE Design

### Embodiment 1

In this embodiment, it is assumed that a unique spatial relation ID exist which has been prior configured by LPP or RRC; in this case the MAC CE just needs to indicate the spatial relation ID.

The MAC CE that points the spatial relation to be used in UL SRS transmission may indicate:

Alternative 1
SRS resource set cell ID, cell ID in which SRS resource set is configured
BWP ID in this serving cell as SRS-Config is per BWP
SRS resource set ID for Rel-15
Information about spatial relation that is assumed for all resources in the SRS resource set for Rel-15

Alternative 2
SRS resource set cell ID, cell ID in which SRS resource set is configured
BWP ID in this serving cell as SRS-Config is per BWP
SRS resource set ID for Rel-16
Information about spatial relation that is assumed for all resources in the SRS resource set for Rel-16

Alternative 3
SRS resource set cell ID, cell ID in which SRS resource set is configured
BWP ID in this serving cell as SRS-Config is per BWP
SRS resource ID
Information about spatial relation that is assumed the SRS resource
Field indicating if more pairs of SRS resource IDs and positioning TCI state Ids are given

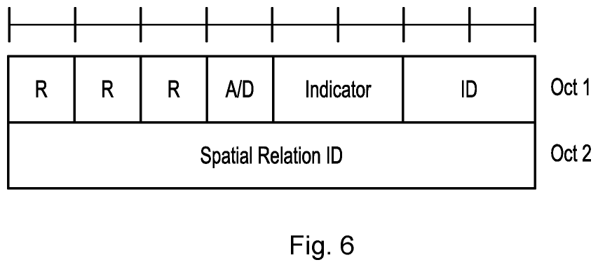

An example (Example 1) MAC CE is shown in FIG. 6.

### Example 1

In this example, considering that up to 16 resource SET can be configured; it is assumed that spatial relation ID would be up to 4 bits to represent each resource set ID. In such case, it is possible to define one octet. Oct 1: A/D, Indication of 3 different alternatives for Embodiment 1 (2 bits), spatial relation ID 4 bits. One bit would be reserved.

If resource ID level spatial information is needed, then the spatial relation ID is 10 bits long. The UE can be configured up to 16 SRS resource sets and each resource set containing 64 resource ID; thus, it is possible to have 1024 unique spatial relation.

At least 2 bits would be required to represent the 3 alternatives.

Thus, 2 octet MAC CE is proposed, as illustrated in FIG. 6.
Oct 1: A/D, Indication of 3 different alternatives for Embodiment 1 (2 bits), 2 MSB of spatial relation, 3 bits would be reserved.
Oct 2: 8 LSB of spatial relation ID-

### Example 1a, Option a for “Information about Spatial Relation”

When frequency layer is known to the UE, i.e. there are only 2 DL PRS sets, if the UE is not configured with positioning TCI state or it cannot be used in the MAC CE, an alternative way of efficiently pointing to a spatial relation is using one of options 1-8 below:
Information about SSB (serving or neighbor)
   1 Serving SSB index
   2 Nonserving PCI+SSBindex
Information about PRS (serving or neighbor)
   3 TRPID resource set ID1
   4 TRPID resource set ID2
Information about SRS
   5 Release 15 SRS set ID or SRS resource ID, BWP ID
   6 Release 16 SRS set ID or SRS resource ID, BWP ID
Information about CSI-RS (serving or neighbor)
   7 Serving NZP-CSI-RS resource ID
   8 Nonserving NZP-CSI-RS resource ID and/or PCI

When frequency layer is unknown to the UE, i.e. there may be up to 8 DL PRS sets, if the UE is not configured with positioning TCI state or it cannot be used in the MAC CE, an alternative way of efficiently pointing to a spatial relation is using one of options 1-8 below:
Information about SSB (serving or neighbor)
   1 Serving SSB index
   2 Nonserving PCI-FSSBindex
Information about PRS (serving or neighbor)
   3 TRPID resource set IDs
   4 TRPID resource set IDs and resource IDs
Information about SRS
   5 Release 15 SRS set ID or SRS resource ID, BWP ID
   6 Release 16 SRS set ID or SRS resource ID, BWP ID
Information about CSI-RS (serving or neighbor)
   7 Serving NZP-CSI-RS resource ID
   8 Nonserving NZP-CSI-RS resource ID and/or PCI

A three bit field is used to indicate the type of the spatial relation among the 8 example options listed above for the respective scenario (frequency layer known/unknown). The idea is to use length X bit string to point to different IDs that UE has received in configuration from LMF server (LPP), or from gNB (RRC). Because these IDs and what they mean are known to the UE by separate configuration (LPP/RRC) the field saves octets in MAC CE design as there is no need to duplicate information.

Use X bit field to define what ID spaces are possible in the MAC CE based on UE capability.

### Example 1 b, Option b for “Information about Spatial Relation”

UE is RRC or LPP configured with a “positioning TCI state” which includes
Information about the spatial relation reference signal (or downlink reference signal), e.g.:
   Information about SSB (serving or neighbor)
   Information about PRS (serving or neighbor)
   Information about SRS
   Information about CSI-RS (serving or neighbor)
Information about QCL type
Other information about the spatial relation

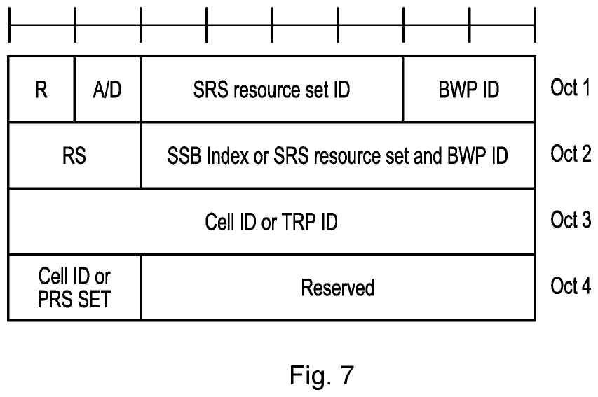

### Example 2 (Illustrated in FIG. 7); Based Upon Embodiment 1 a

Currently, in Rel-16 UE does not support CSI-RS for spatial relation; thus in this example a further optimization is considered.

A total of 4 octet MAC CE is defined.
Oct 1: R (reserved) 1 bit, A/D 1 bit, SRS Resource Set ID 4 bits, BWP ID 2 bits
Oct 2: RS 2 bits, SSB Index 6 bits or SRS resource set ID 4 bits and BWP ID 2 bits
Oct 3: Cell ID (MSB 8 bits) or TRP ID (Least significant 6 bits)
Oct 4: Cell ID (LSB 2 bits) or DL PRS Resource set ID (MSB 1 bit); the last 6 bits are reserved

It is possible that if long global TRP ID notation is required (for example in LTE; TP is defined as 12 bits) or further larger Resource set ID is required; for example, 3 bits up to 8 bits if global TRP ID notation is used; in that case the Oct 4 reserved bits could be further used.

Explanation of the Bits:

RS Bits: Reference Signals that can be used for spatial relationship; SSB, DL-PRS, SRS

Optimizations:

The 2-bit RS can be used to indicate both RS and the 1 bit to distinguish between the Rel-15 and Rel-16 SRS Resource set/ID:
00->DL PRS
01->SSB
10->UL SRS and Resource set and resource ID for Rel-15
11->UL SRS and Resource set and resource ID for Rel-16.

Depending upon RS; in the second octet the SSB index or the neighbor UL SRS Resource set ID and BWP ID can be shared.

Neighbor Cell ID: Neighbor cell ID would be needed for SSB. In NR the cell ID is from 0 to 1007; thus requiring 10 bits

SSB Index: This is neighbor beam Index; Maximum number of SSB index per cell are 64; that is 6 bits.

Below parameters would be needed for SRS Parameters for serving cell SRS activation and separately for spatial reference:

SRS Resource Set: This is 4-bit ID for resource set.

UL BWP ID: This is 2-bit ID for UL SRS BWP.

Depending upon the RS, the Cell ID or TRP ID bits in the 3rd octet can be shared. Since TRP ID is only 8 bits the 2 MSB bits would be set 00 for TRP ID.

In the 4th octet, the 2 bits can be shared for the cell ID last 2 bits or if the spatial relation is considered for TRP ID; then each TRP ID will contain 2 resource set; thus 1 bit would be used-

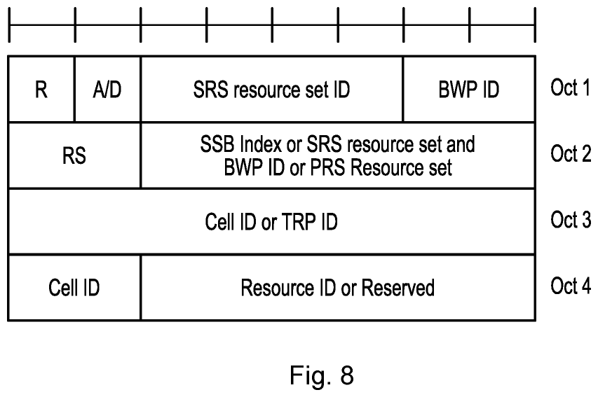

### Example 3 (Illustrated in FIG. 8); Based Upon Embodiment 1a where Up to 8 Resource Set IDs are Considered and Further Resource ID is Also Considered

Currently, in Rel-16 UE does not support CSI-RS for spatial relation; thus in this example a further optimization is considered.

A total of 4 octet MAC CE is defined.

Oct 1: R (reserved) 1 bit, A/D 1 bit, SRS Resource Set ID 4 bits, BWP ID 2 bits

Oct 2: RS 2 bits, (SSB Index 6 bits) or (SRS resource set ID 4 bits and BWP ID 2 bits) or PRS resource set (3 bits) and one bit indicator to specify if Resource ID is present or not.

Oct 3: Cell ID (MSB 8 bits) or TRP ID (Most significant 6 bits)

Oct 4: Cell ID (LSB 2 bits) or Resource ID (LSB 2 bits); the last 6 bits are reserved

Depending upon RS; in the second octet the SSB index or the neighbor UL SRS Resource set ID and BWP ID or PRS resource set (3 bits) and 1 bit optional to indicate whether resource ID is present or not can be shared.

Depending upon the RS, the Cell ID or TRP ID bits in the 3rd octet can be shared. Since TRP ID is only 8 bits the 2 LSB bits can be used for 2 MSB bits for resource ID or can be reserved.

In the 4th octet, the 2 bits can be shared for the cell ID last 2 bits or if the spatial relation is considered for TRP ID; and if resource ID is considered then the last octet would contain the resource ID

The other remains same as in example 2: The example MAC CE payload structure is shown in FIG. 8.

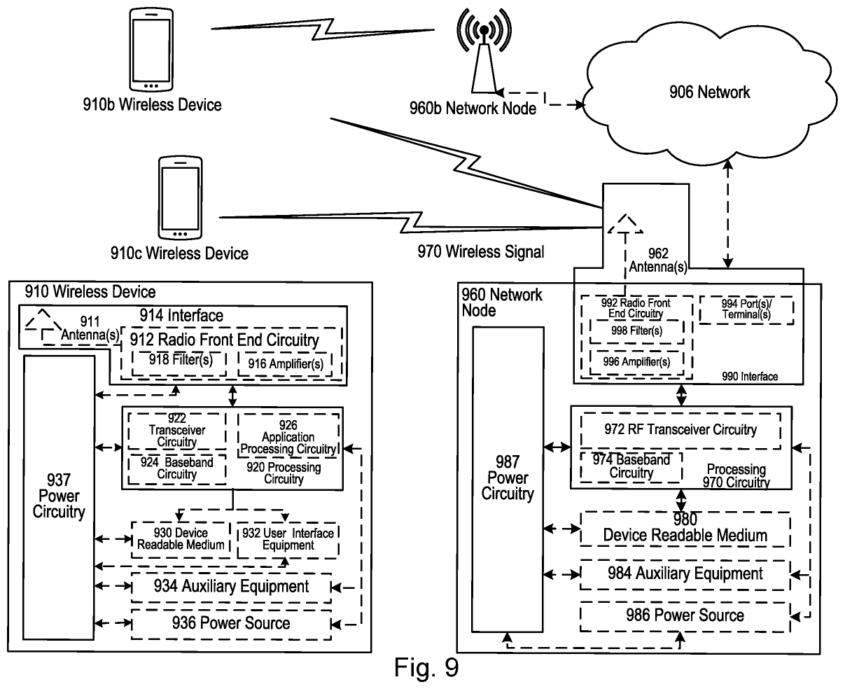

FIG. 9 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 906, network nodes 960 and 960b, and WDs 910, 910b, and 910c. In practice, a wireless network may further include any additional elements suitable to support communication between wireless devices or between a wireless device and another communication device, such as a landline telephone, a service provider, or any other network node or end device. Of the illustrated components, network node 960 and wireless device (WD) 910 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 960 and WD 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 960 includes processing circuitry 970, device readable medium 980, interface 990, auxiliary equipment 984, power source 986, power circuitry 987, and antenna 962. Although network node 960 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 960 are depicted as single boxes located within a larger box, or nested within multiple boxes, in practice, a network node may comprise multiple different physical components that make up a single illustrated component (e.g., device readable medium 980 may comprise multiple separate hard drives as well as multiple RAM modules).

Similarly, network node 960 may be composed of multiple physically separate components (e.g., a NodeB component and a RNC component, or a BTS component and a BSC component, etc.), which may each have their own respective components. In certain scenarios in which network node 960 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 960 may be configured to support multiple radio access technologies (RATs). In such embodiments, some components may be duplicated (e.g., separate device readable medium 980 for the different RATs) and some components may be reused (e.g., the same antenna 962 may be shared by the RATs). Network node 960 may also include multiple sets of the various illustrated components for different wireless technologies integrated into network node 960, such as, for example, GSM, WCDMA, LTE, NR, WiFi, or Bluetooth wireless technologies. These wireless technologies may be integrated into the same or different chip or set of chips and other components within network node 960.

Processing circuitry 970 is configured to perform any determining, calculating, or similar operations (e.g., certain obtaining operations) described herein as being provided by a network node. These operations performed by processing circuitry 970 may include processing information obtained by processing circuitry 970 by, for example, converting the obtained information into other information, comparing the obtained information or converted information to information stored in the network node, and/or performing one or more operations based on the obtained information or converted information, and as a result of said processing making a determination.

Processing circuitry 970 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 960 components, such as device readable medium 980, network node 960 functionality. For example, processing circuitry 970 may execute instructions stored in device readable medium 980 or in memory within processing circuitry 970. Such functionality may include providing any of the various wireless features, functions, or benefits discussed herein. In some embodiments, processing circuitry 970 may include a system on a chip (SOC).

In some embodiments, processing circuitry 970 may include one or more of radio frequency (RF) transceiver circuitry 972 and baseband processing circuitry 974. In some embodiments, radio frequency (RF) transceiver circuitry 972 and baseband processing circuitry 974 may be on separate chips (or sets of chips), boards, or units, such as radio units and digital units. In alternative embodiments, part or all of RF transceiver circuitry 972 and baseband processing circuitry 974 may be on the same chip or set of chips, boards, or units

In certain embodiments, some or all of the functionality described herein as being provided by a network node, base station, eNB or other such network device may be performed by processing circuitry 970 executing instructions stored on device readable medium 980 or memory within processing circuitry 970. In alternative embodiments, some or all of the functionality may be provided by processing circuitry 970 without executing instructions stored on a separate or discrete device readable medium, such as in a hard-wired manner. In any of those embodiments, whether executing instructions stored on a device readable storage medium or not, processing circuitry 970 can be configured to perform the described functionality. The benefits provided by such functionality are not limited to processing circuitry 970 alone or to other components of network node 960, but are enjoyed by network node 960 as a whole, and/or by end users and the wireless network generally.

Device readable medium 980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 970. Device readable medium 980 may store any suitable instructions, data or information, including a computer program, software, an application including one or more of logic, rules, code, tables, etc. and/or other instructions capable of being executed by processing circuitry 970 and, utilized by network node 960. Device readable medium 980 may be used to store any calculations made by processing circuitry 970 and/or any data received via interface 990. In some embodiments, processing circuitry 970 and device readable medium 980 may be considered to be integrated.

Interface 990 is used in the wired or wireless communication of signalling and/or data between network node 960, network 906, and/or WDs 910. As illustrated, interface 990 comprises port(s)/terminal(s) 994 to send and receive data, for example to and from network 906 over a wired connection. Interface 990 also includes radio front end circuitry 992 that may be coupled to, or in certain embodiments a part of, antenna 962. Radio front end circuitry 992 comprises filters 998 and amplifiers 996. Radio front end circuitry 992 may be connected to antenna 962 and processing circuitry 970. Radio front end circuitry may be configured to condition signals communicated between antenna 962 and processing circuitry 970. Radio front end circuitry 992 may receive digital data that is to be sent out to other network nodes or WDs via a wireless connection. Radio front end circuitry 992 may convert the digital data into a radio signal having the appropriate channel and bandwidth parameters using a combination of filters 998 and/or amplifiers 996. The radio signal may then be transmitted via antenna 962. Similarly, when receiving data, antenna 962 may collect radio signals which are then converted into digital data by radio front end circuitry 992. The digital data may be passed to processing circuitry 970. In other embodiments, the interface may comprise different components and/or different combinations of components.

In certain alternative embodiments, network node 960 may not include separate radio front end circuitry 992, instead, processing circuitry 970 may comprise radio front end circuitry and may be connected to antenna 962 without separate radio front end circuitry 992. Similarly, in some embodiments, all or some of RF transceiver circuitry 972 may be considered a part of interface 990. In still other embodiments, interface 990 may include one or more ports or terminals 994, radio front end circuitry 992, and RF transceiver circuitry 972, as part of a radio unit (not shown), and interface 990 may communicate with baseband processing circuitry 974, which is part of a digital unit (not shown).

Antenna 962 may include one or more antennas, or antenna arrays, configured to send and/or receive wireless signals. Antenna 962 may be coupled to radio front end circuitry 990 and may be any type of antenna capable of transmitting and receiving data and/or signals wirelessly. In some embodiments, antenna 962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 962 may be separate from network node 960 and may be connectable to network node 960 through an interface or port.

Antenna 962, interface 990, and/or processing circuitry 970 may be configured to perform any receiving operations and/or certain obtaining operations described herein as being performed by a network node. Any information, data and/or signals may be received from a wireless device, another network node and/or any other network equipment. Similarly, antenna 962, interface 990, and/or processing circuitry 970 may be configured to perform any transmitting operations described herein as being performed by a network node. Any information, data and/or signals may be transmitted to a wireless device, another network node and/or any other network equipment.

Power circuitry 987 may comprise, or be coupled to, power management circuitry and is configured to supply the components of network node 960 with power for performing the functionality described herein. Power circuitry 987 may receive power from power source 986. Power source 986 and/or power circuitry 987 may be configured to provide power to the various components of network node 960 in a form suitable for the respective components (e.g., at a voltage and current level needed for each respective component). Power source 986 may either be included in, or external to, power circuitry 987 and/or network node 960. For example, network node 960 may be connectable to an external power source (e.g., an electricity outlet) via an input circuitry or interface such as an electrical cable, whereby the external power source supplies power to power circuitry 987. As a further example, power source 986 may comprise a source of power in the form of a battery or battery pack which is connected to, or integrated in, power circuitry 987. The battery may provide backup power should the external power source fail. Other types of power sources, such as photovoltaic devices, may also be used.

Alternative embodiments of network node 960 may include additional components beyond those shown in FIG. 9 that may be responsible for providing certain aspects of the network node's functionality, including any of the functionality described herein and/or any functionality necessary to support the subject matter described herein. For example, network node 960 may include user interface equipment to allow input of information into network node 960 and to allow output of information from network node 960. This may allow a user to perform diagnostic, maintenance, repair, and other administrative functions for network node 960.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 910 includes antenna 911, interface 914, processing circuitry 920, device readable medium 930, user interface equipment 932, auxiliary equipment 934, power source 936 and power circuitry 937. WD 910 may include multiple sets of one or more of the illustrated components for different wireless technologies supported by WD 910, such as, for example, GSM, WCDMA, LTE, NR, WiFi, WiMAX, or Bluetooth wireless technologies, just to mention a few. These wireless technologies may be integrated into the same or different chips or set of chips as other components within WD 910.

Antenna 911 may include one or more antennas or antenna arrays, configured to send and/or receive wireless signals, and is connected to interface 914. In certain alternative embodiments, antenna 911 may be separate from WD 910 and be connectable to WD 910 through an interface or port. Antenna 911, interface 914, and/or processing circuitry 920 may be configured to perform any receiving or transmitting operations described herein as being performed by a WD. Any information, data and/or signals may be received from a network node and/or another WD. In some embodiments, radio front end circuitry and/or antenna 911 may be considered an interface.

As illustrated, interface 914 comprises radio front end circuitry 912 and antenna 911. Radio front end circuitry 912 comprise one or more filters 918 and amplifiers 916. Radio front end circuitry 914 is connected to antenna 911 and processing circuitry 920, and is configured to condition signals communicated between antenna 911 and processing circuitry 920. Radio front end circuitry 912 may be coupled to or a part of antenna 911. In some embodiments, WD 910 may not include separate radio front end circuitry 912; rather, processing circuitry 920 may comprise radio front end circuitry and may be connected to antenna 911. Similarly, in some embodiments, some or all of RF transceiver circuitry 922 may be considered a part of interface 914. Radio front end circuitry 912 may receive digital data that is to be sent out to other network nodes or WDs via a wireless connection. Radio front end circuitry 912 may convert the digital data into a radio signal having the appropriate channel and bandwidth parameters using a combination of filters 918 and/or amplifiers 916. The radio signal may then be transmitted via antenna 911. Similarly, when receiving data, antenna 911 may collect radio signals which are then converted into digital data by radio front end circuitry 912. The digital data may be passed to processing circuitry 920. In other embodiments, the interface may comprise different components and/or different combinations of components.

Processing circuitry 920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 910 components, such as device readable medium 930, WD 910 functionality. Such functionality may include providing any of the various wireless features or benefits discussed herein. For example, processing circuitry 920 may execute instructions stored in device readable medium 930 or in memory within processing circuitry 920 to provide the functionality disclosed herein.

As illustrated, processing circuitry 920 includes one or more of RF transceiver circuitry 922, baseband processing circuitry 924, and application processing circuitry 926. In other embodiments, the processing circuitry may comprise different components and/or different combinations of components. In certain embodiments processing circuitry 920 of WD 910 may comprise a SOC. In some embodiments, RF transceiver circuitry 922, baseband processing circuitry 924, and application processing circuitry 926 may be on separate chips or sets of chips. In alternative embodiments, part or all of baseband processing circuitry 924 and application processing circuitry 926 may be combined into one chip or set of chips, and RF transceiver circuitry 922 may be on a separate chip or set of chips. In still alternative embodiments, part or all of RF transceiver circuitry 922 and baseband processing circuitry 924 may be on the same chip or set of chips, and application processing circuitry 926 may be on a separate chip or set of chips. In yet other alternative embodiments, part or all of RF transceiver circuitry 922, baseband processing circuitry 924, and application processing circuitry 926 may be combined in the same chip or set of chips. In some embodiments, RF transceiver circuitry 922 may be a part of interface 914. RF transceiver circuitry 922 may condition RF signals for processing circuitry 920.

In certain embodiments, some or all of the functionality described herein as being performed by a WD may be provided by processing circuitry 920 executing instructions stored on device readable medium 930, which in certain embodiments may be a computer-readable storage medium. In alternative embodiments, some or all of the functionality may be provided by processing circuitry 920 without executing instructions stored on a separate or discrete device readable storage medium, such as in a hard-wired manner. In any of those particular embodiments, whether executing instructions stored on a device readable storage medium or not, processing circuitry 920 can be configured to perform the described functionality. The benefits provided by such functionality are not limited to processing circuitry 920 alone or to other components of WD 910, but are enjoyed by WD 910 as a whole, and/or by end users and the wireless network generally.

Processing circuitry 920 may be configured to perform any determining, calculating, or similar operations (e.g., certain obtaining operations) described herein as being performed by a WD. These operations, as performed by processing circuitry 920, may include processing information obtained by processing circuitry 920 by, for example, converting the obtained information into other information, comparing the obtained information or converted information to information stored by WD 910, and/or performing one or more operations based on the obtained information or converted information, and as a result of said processing making a determination.

Device readable medium 930 may be operable to store a computer program, software, an application including one or more of logic, rules, code, tables, etc. and/or other instructions capable of being executed by processing circuitry 920. Device readable medium 930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 920. In some embodiments, processing circuitry 920 and device readable medium 930 may be considered to be integrated.

User interface equipment 932 may provide components that allow for a human user to interact with WD 910. Such interaction may be of many forms, such as visual, audial, tactile, etc. User interface equipment 932 may be operable to produce output to the user and to allow the user to provide input to WD 910. The type of interaction may vary depending on the type of user interface equipment 932 installed in WD 910. For example, if WD 910 is a smart phone, the interaction may be via a touch screen; if WD 910 is a smart meter, the interaction may be through a screen that provides usage (e.g., the number of gallons used) or a speaker that provides an audible alert (e.g., if smoke is detected). User interface equipment 932 may include input interfaces, devices and circuits, and output interfaces, devices and circuits. User interface equipment 932 is configured to allow input of information into WD 910, and is connected to processing circuitry 920 to allow processing circuitry 920 to process the input information. User interface equipment 932 may include, for example, a microphone, a proximity or other sensor, keys/buttons, a touch display, one or more cameras, a USB port, or other input circuitry. User interface equipment 932 is also configured to allow output of information from WD 910, and to allow processing circuitry 920 to output information from WD 910. User interface equipment 932 may include, for example, a speaker, a display, vibrating circuitry, a USB port, a headphone interface, or other output circuitry. Using one or more input and output interfaces, devices, and circuits, of user interface equipment 932, WD 910 may communicate with end users and/or the wireless network, and allow them to benefit from the functionality described herein.

Auxiliary equipment 934 is operable to provide more specific functionality which may not be generally performed by WDs. This may comprise specialized sensors for doing measurements for various purposes, interfaces for additional types of communication such as wired communications etc. The inclusion and type of components of auxiliary equipment 934 may vary depending on the embodiment and/or scenario.

Power source 936 may, in some embodiments, be in the form of a battery or battery pack. Other types of power sources, such as an external power source (e.g., an electricity outlet), photovoltaic devices or power cells, may also be used. WD 910 may further comprise power circuitry 937 for delivering power from power source 936 to the various parts of WD 910 which need power from power source 936 to carry out any functionality described or indicated herein. Power circuitry 937 may in certain embodiments comprise power management circuitry. Power circuitry 937 may additionally or alternatively be operable to receive power from an external power source; in which case WD 910 may be connectable to the external power source (such as an electricity outlet) via input circuitry or an interface such as an electrical power cable. Power circuitry 937 may also in certain embodiments be operable to deliver power from an external power source to power source 936. This may be, for example, for the charging of power source 936. Power circuitry 937 may perform any formatting, converting, or other modification to the power from power source 936 to make the power suitable for the respective components of WD 910 to which power is supplied.

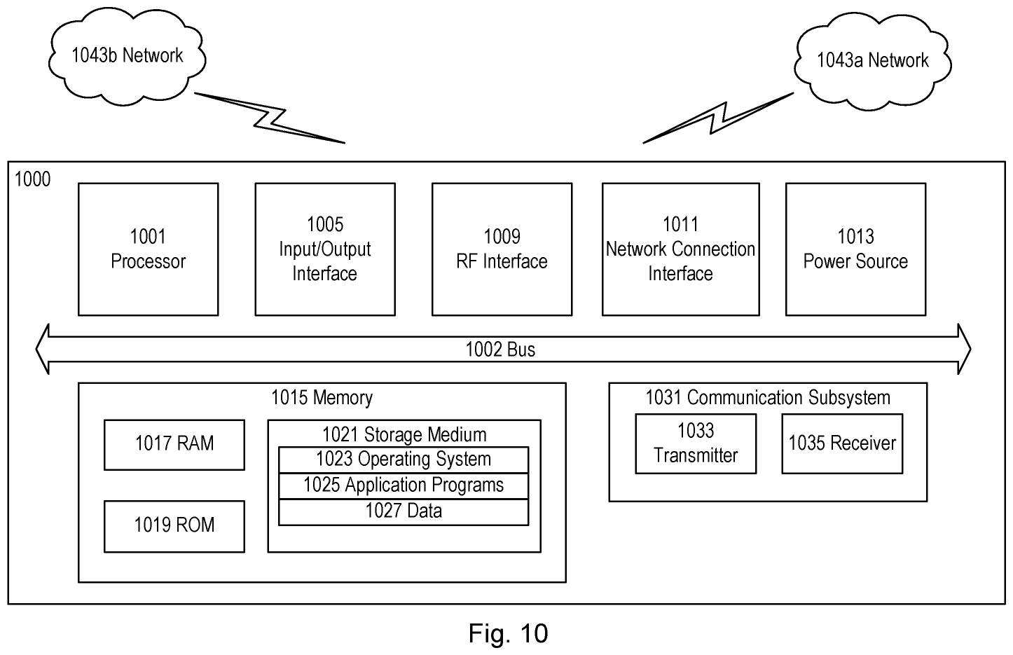

FIG. 10 illustrates a User Equipment in accordance with some embodiments

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1000 may be any UE identified by the 3^{rd} Generation Partnership Project (3GPP), including a NB-IoT UE, a machine type communication (MTC) UE, and/or an enhanced MTC (eMTC) UE. UE 1000, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1000 includes processing circuitry 1001 that is operatively coupled to input/output interface 1005, radio frequency (RF) interface 1009, network connection interface 1011, memory 1015 including random access memory (RAM) 1017, read-only memory (ROM) 1019, and storage medium 1021 or the like, communication subsystem 1031, power source 1033, and/or any other component, or any combination thereof. Storage medium 1021 includes operating system 1023, application program 1025, and data 1027. In other embodiments, storage medium 1021 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1001 may be configured to process computer instructions and data. Processing circuitry 1001 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1001 may include two central processing units (CPUs). Data may be information in a form suitable for use by a computer.

In the depicted embodiment, input/output interface 1005 may be configured to provide a communication interface to an input device, output device, or input and output device. UE 1000 may be configured to use an output device via input/output interface 1005. An output device may use the same type of interface port as an input device. For example, a USB port may be used to provide input to and output from UE 1000. The output device may be a speaker, a sound card, a video card, a display, a monitor, a printer, an actuator, an emitter, a smartcard, another output device, or any combination thereof. UE 1000 may be configured to use an input device via input/output interface 1005 to allow a user to capture information into UE 1000. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1009 may be configured to provide a communication interface to RF components such as a transmitter, a receiver, and an antenna. Network connection interface 1011 may be configured to provide a communication interface to network 1043a. Network 1043a may encompass wired and/or wireless networks such as a local-area network (LAN), a wide-area network (WAN), a computer network, a wireless network, a telecommunications network, another like network or any combination thereof. For example, network 1043a may comprise a Wi-Fi network. Network connection interface 1011 may be configured to include a receiver and a transmitter interface used to communicate with one or more other devices over a communication network according to one or more communication protocols, such as Ethernet, TCP/IP, SONET, ATM, or the like. Network connection interface 1011 may implement receiver and transmitter functionality appropriate to the communication network links (e.g., optical, electrical, and the like). The transmitter and receiver functions may share circuit components, software or firmware, or alternatively may be implemented separately.

RAM 1017 may be configured to interface via bus 1002 to processing circuitry 1001 to provide storage or caching of data or computer instructions during the execution of software programs such as the operating system, application programs, and device drivers. ROM 1019 may be configured to provide computer instructions or data to processing circuitry 1001. For example, ROM 1019 may be configured to store invariant low-level system code or data for basic system functions such as basic input and output (I/O), startup, or reception of keystrokes from a keyboard that are stored in a non-volatile memory. Storage medium 1021 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1021 may be configured to include operating system 1023, application program 1025 such as a web browser application, a widget or gadget engine or another application, and data file 1027. Storage medium 1021 may store, for use by UE 1000, any of a variety of various operating systems or combinations of operating systems.

Storage medium 1021 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1021 may allow UE 1000 to access computer-executable instructions, application programs or the like, stored on transitory or non-transitory memory media, to off-load data, or to upload data. An article of manufacture, such as one utilizing a communication system may be tangibly embodied in storage medium 1021, which may comprise a device readable medium.

In FIG. 10, processing circuitry 1001 may be configured to communicate with network 1043b using communication subsystem 1031. Network 1043a and network 1043b may be the same network or networks or different network or networks. Communication subsystem 1031 may be configured to include one or more transceivers used to communicate with network 1043b. For example, communication subsystem 1031 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1033 and/or receiver 1035 to implement transmitter or receiver functionality, respectively, appropriate to the RAN links (e.g., frequency allocations and the like). Further, transmitter 1033 and receiver 1035 of each transceiver may share circuit components, software or firmware, or alternatively may be implemented separately.

In the illustrated embodiment, the communication functions of communication subsystem 1031 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1031 may include cellular communication, Wi-Fi communication, Bluetooth communication, and GPS communication. Network 1043b may encompass wired and/or wireless networks such as a local-area network (LAN), a wide-area network (WAN), a computer network, a wireless network, a telecommunications network, another like network or any combination thereof. For example, network 1043b may be a cellular network, a Wi-Fi network, and/or a near-field network. Power source 1013 may be configured to provide alternating current (AC) or direct current (DC) power to components of UE 1000.

The features, benefits and/or functions described herein may be implemented in one of the components of UE 1000 or partitioned across multiple components of UE 1000. Further, the features, benefits, and/or functions described herein may be implemented in any combination of hardware, software or firmware. In one example, communication subsystem 1031 may be configured to include any of the components described herein. Further, processing circuitry 1001 may be configured to communicate with any of such components over bus 1002. In another example, any of such components may be represented by program instructions stored in memory that when executed by processing circuitry 1001 perform the corresponding functions described herein. In another example, the functionality of any of such components may be partitioned between processing circuitry 1001 and communication subsystem 1031. In another example, the non-computationally intensive functions of any of such components may be implemented in software or firmware and the computationally intensive functions may be implemented in hardware.

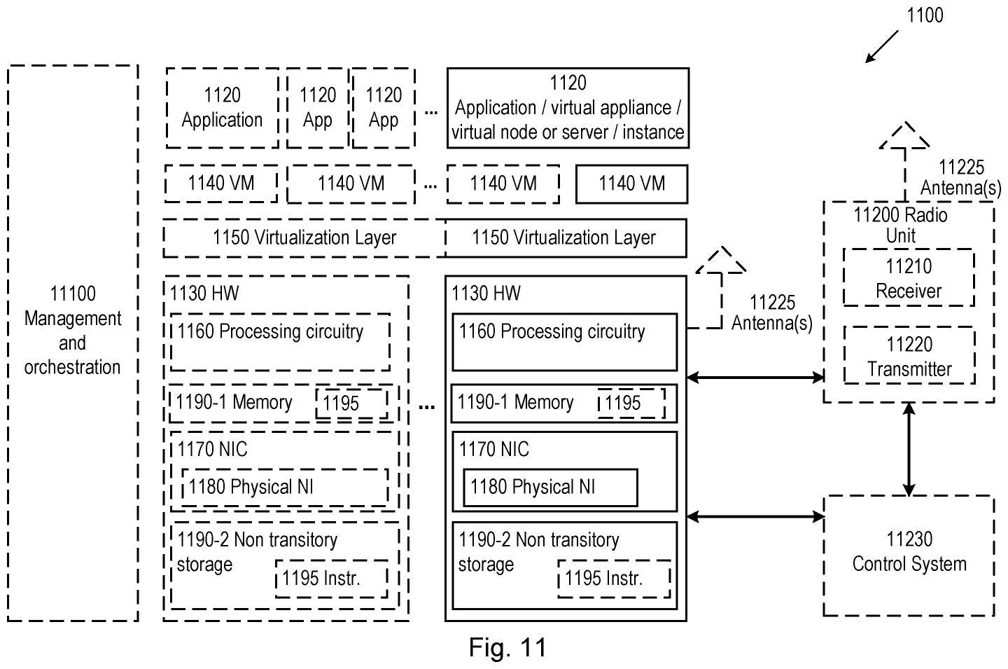

FIG. 11 illustrates a virtualization environment in accordance with some embodiments

FIG. 11 is a schematic block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1100 hosted by one or more of hardware nodes 1130. Further, in embodiments in which the virtual node is not a radio access node or does not require radio connectivity (e.g., a core network node), then the network node may be entirely virtualized.

The functions may be implemented by one or more applications 1120 (which may alternatively be called software instances, virtual appliances, network functions, virtual nodes, virtual network functions, etc.) operative to implement some of the features, functions, and/or benefits of some of the embodiments disclosed herein. Applications 1120 are run in virtualization environment 1100 which provides hardware 1130 comprising processing circuitry 1160 and memory 1190. Memory 1190 contains instructions 1195 executable by processing circuitry 1160 whereby application 1120 is operative to provide one or more of the features, benefits, and/or functions disclosed herein.

Virtualization environment 1100, comprises general-purpose or special-purpose network hardware devices 1130 comprising a set of one or more processors or processing circuitry 1160, which may be commercial off-the-shelf (COTS) processors, dedicated Application Specific Integrated Circuits (ASICs), or any other type of processing circuitry including digital or analog hardware components or special purpose processors. Each hardware device may comprise memory 1190-1 which may be non-persistent memory for temporarily storing instructions 1195 or software executed by processing circuitry 1160. Each hardware device may comprise one or more network interface controllers (NICs) 1170, also known as network interface cards, which include physical network interface 1180. Each hardware device may also include non-transitory, persistent, machine-readable storage media 1190-2 having stored therein software 1195 and/or instructions executable by processing circuitry 1160. Software 1195 may include any type of software including software for instantiating one or more virtualization layers 1150 (also referred to as hypervisors), software to execute virtual machines 1140 as well as software allowing it to execute functions, features and/or benefits described in relation with some embodiments described herein.

Virtual machines 1140, comprise virtual processing, virtual memory, virtual networking or interface and virtual storage, and may be run by a corresponding virtualization layer 1150 or hypervisor. Different embodiments of the instance of virtual appliance 1120 may be implemented on one or more of virtual machines 1140, and the implementations may be made in different ways.

During operation, processing circuitry 1160 executes software 1195 to instantiate the hypervisor or virtualization layer 1150, which may sometimes be referred to as a virtual machine monitor (VMM). Virtualization layer 1150 may present a virtual operating platform that appears like networking hardware to virtual machine 1140.

As shown in FIG. 11, hardware 1130 may be a standalone network node with generic or specific components. Hardware 1130 may comprise antenna 11225 and may implement some functions via virtualization. Alternatively, hardware 1130 may be part of a larger cluster of hardware (e.g. such as in a data center or customer premise equipment (CPE)) where many hardware nodes work together and are managed via management and orchestration (MANO) 11100, which, among others, oversees lifecycle management of applications 1120.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1140 may be a software implementation of a physical machine that runs programs as if they were executing on a physical, non-virtualized machine. Each of virtual machines 1140, and that part of hardware 1130 that executes that virtual machine, be it hardware dedicated to that virtual machine and/or hardware shared by that virtual machine with others of the virtual machines 1140, forms a separate virtual network elements (VNE).

Still in the context of NFV, Virtual Network Function (VNF) is responsible for handling specific network functions that run in one or more virtual machines 1140 on top of hardware networking infrastructure 1130 and corresponds to application 1120 in FIG. 11.

In some embodiments, one or more radio units 11200 that each include one or more transmitters 11220 and one or more receivers 11210 may be coupled to one or more antennas 11225. Radio units 11200 may communicate directly with hardware nodes 1130 via one or more appropriate network interfaces and may be used in combination with the virtual components to provide a virtual node with radio capabilities, such as a radio access node or a base station.

In some embodiments, some signalling can be effected with the use of control system 11230 which may alternatively be used for communication between the hardware nodes 1130 and radio units 11200.

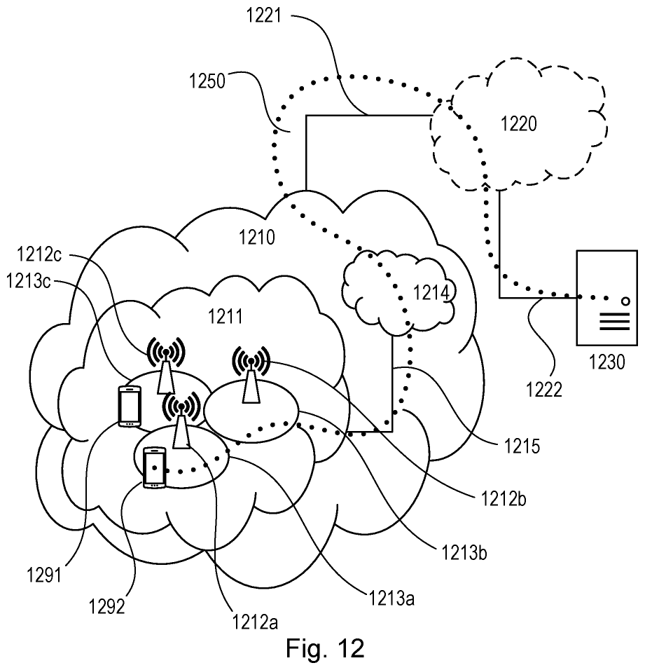

FIG. 12 illustrates a telecommunication network connected via an intermediate network to a host computer in accordance with some embodiments.

With reference to FIG. 12, in accordance with an embodiment, a communication system includes telecommunication network 1210, such as a 3GPP-type cellular network, which comprises access network 1211, such as a radio access network, and core network 1214. Access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

Telecommunication network 1210 is itself connected to host computer 1230, which may be embodied in the hardware and/or software of a standalone server, a cloud-implemented server, a distributed server or as processing resources in a server farm. Host computer 1230 may be under the ownership or control of a service provider, or may be operated by the service provider or on behalf of the service provider. Connections 1221 and 1222 between telecommunication network 1210 and host computer 1230 may extend directly from core network 1214 to host computer 1230 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 1230. The connectivity may be described as an over-the-top (OTT) connection 1250. Host computer 1230 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 1230 to be forwarded (e.g., handed over) to a connected UE 1291. Similarly, base station 1212 need not be aware of the future routing of an outgoing uplink communication originating from the UE 1291 towards the host computer 1230.

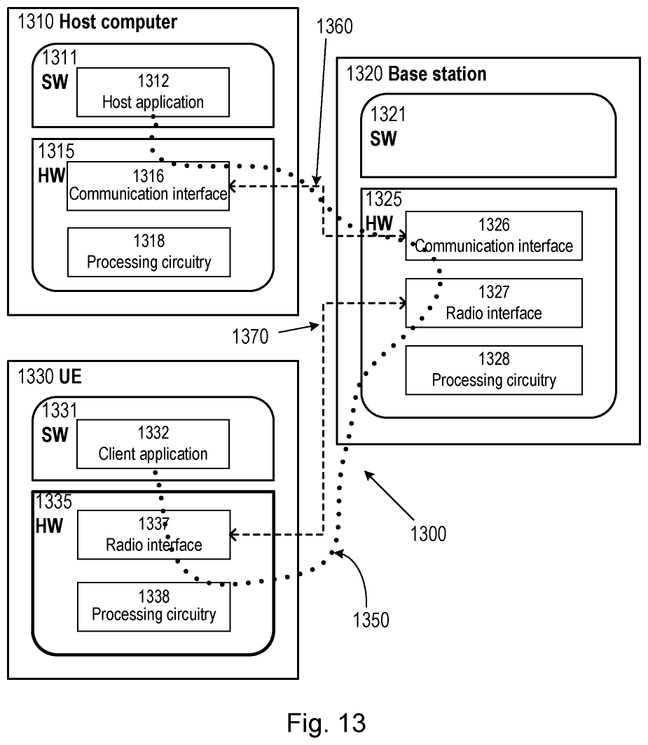

FIG. 13 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system 1300, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318. Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350.

Communication system 1300 further includes base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 1230, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment. More precisely, the teachings of these embodiments may improve the data rate, latency, and/or power consumption, and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

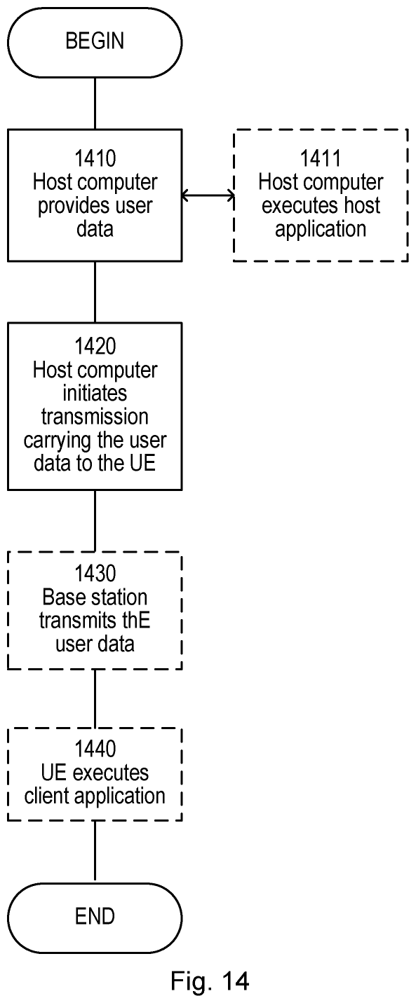

FIG. 14 illustrates methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

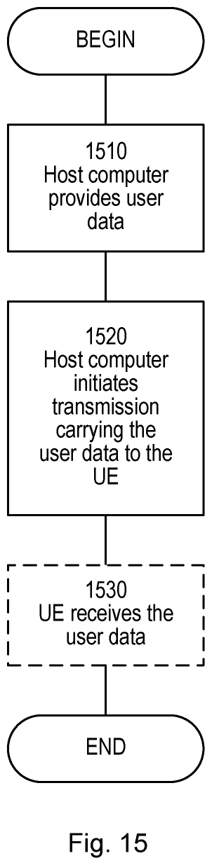

FIG. 15 illustrates methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE. The transmission may pass via the base station, in accordance with the teachings of the embodiments described throughout this disclosure. In step 1530 (which may be optional), the UE receives the user data carried in the transmission.

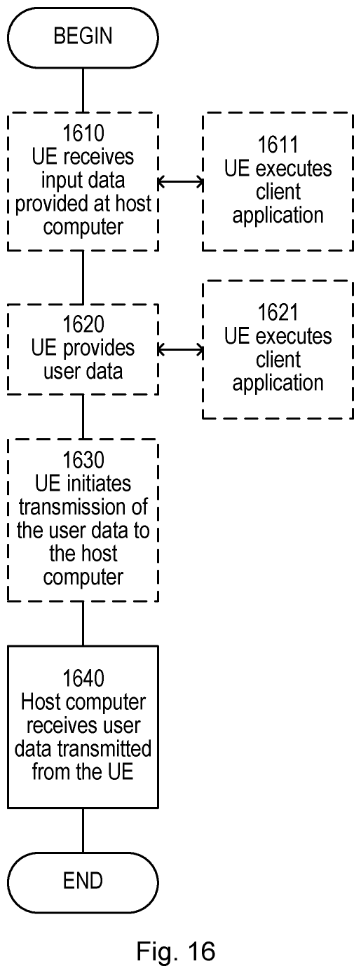

FIG. 16 illustrates methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

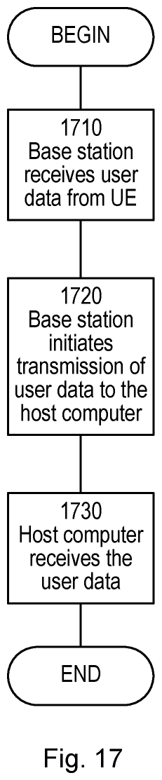

FIG. 17 illustrates methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

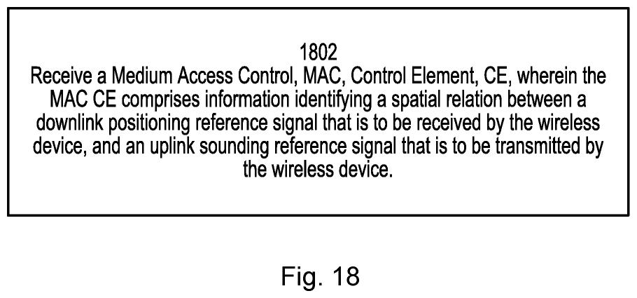

FIG. 18: Method in accordance with some embodiments

FIG. 18 depicts a method performed by a wireless device. In accordance with particular embodiments, the method comprises step 1802 of receiving a Medium Access Control, MAC, Control Element, CE, wherein the MAC CE comprises information identifying a spatial relation between a downlink positioning reference signal that is to be received by the wireless device, and an uplink sounding reference signal that is to be transmitted by the wireless device.

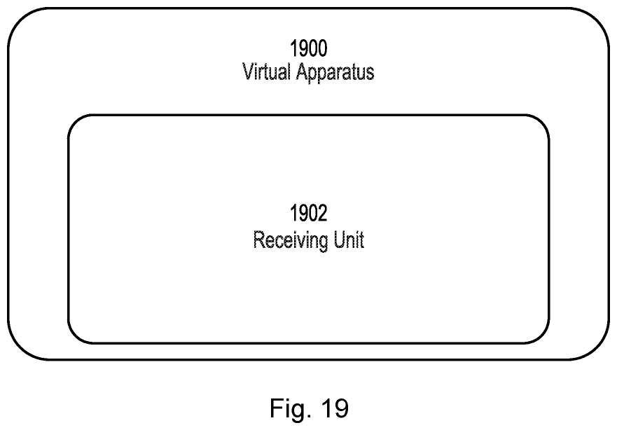

FIG. 19: Virtualization apparatus in accordance with some embodiments

FIG. 19 illustrates a schematic block diagram of an apparatus 1900 in a wireless network (for example, the wireless network shown in FIG. 9). The apparatus may be implemented in a wireless device or network node (e.g., wireless device 910 or network node 960 shown in FIG. 9). Apparatus 1900 is operable to carry out the example method described with reference to FIG. 18 and possibly any other processes or methods disclosed herein. It is also to be understood that the method of FIG. 18 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1902 and any other suitable units of apparatus 1900 to perform corresponding functions according one or more embodiments of the present disclosure.

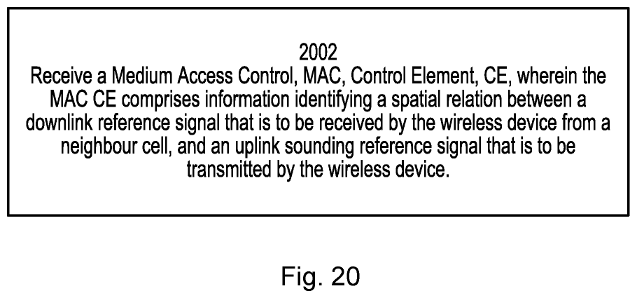

As illustrated in FIG. 19, apparatus 1900 includes receiving unit 1902, which is configured to receive a Medium Access Control, MAC, Control Element, CE, wherein the MAC CE comprises information identifying a spatial relation between a downlink positioning reference signal that is to be received by the wireless device, and an uplink sounding reference signal that is to be transmitted by the wireless device.
FIG. 20 illustrates a method in accordance with some embodiments.

FIG. 20 depicts a method performed by a wireless device. In accordance with particular embodiments, the method comprises step 2002 of receiving a Medium Access Control, MAC, Control Element, CE, wherein the MAC CE comprises information identifying a spatial relation between a downlink reference signal that is to be received by the wireless device from a neighbour cell, and an uplink sounding reference signal that is to be transmitted by the wireless device.

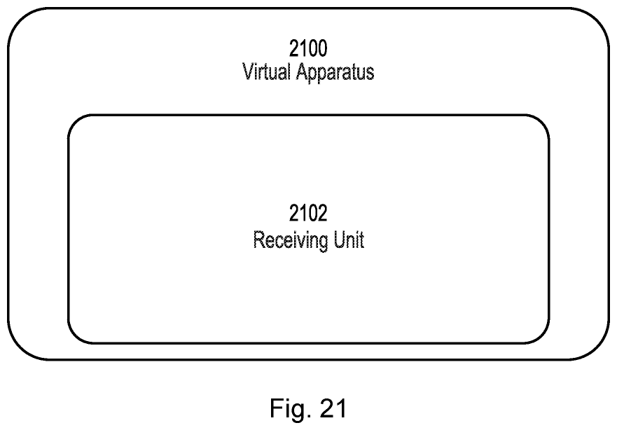

FIG. 21 illustrates a virtualization apparatus in accordance with some embodiments.

FIG. 21 illustrates a schematic block diagram of an apparatus 2100 in a wireless network (for example, the wireless network shown in FIG. 9). The apparatus may be implemented in a wireless device or network node (e.g., wireless device 910 or network node 960 shown in FIG. 9). Apparatus 2100 is operable to carry out the example method described with reference to FIG. 20 and possibly any other processes or methods disclosed herein. It is also to be understood that the method of FIG. 20 is not necessarily carried out solely by apparatus 2100. At least some operations of the method can be performed by one or more other entities.

Virtual Apparatus 2100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2102 and any other suitable units of apparatus 2100 to perform corresponding functions according one or more embodiments of the present disclosure.

As illustrated in FIG. 21, apparatus 2100 includes receiving unit 2102, which is configured to receive a Medium Access Control, MAC, Control Element, CE, wherein the MAC CE comprises information identifying a spatial relation between a positioning reference signal that is to be received by the wireless device from a neighbour cell, and an uplink sounding reference signal that is to be transmitted by the wireless device.

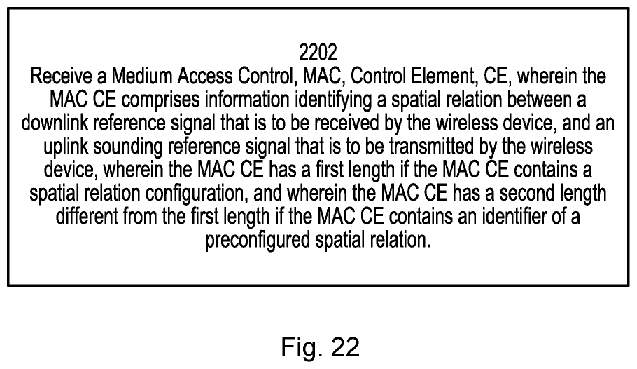

FIG. 22 illustrates a method in accordance with some embodiments.

FIG. 22 depicts a method performed by a wireless device in accordance with particular embodiments. The method comprises step 2202 of receiving a Medium Access Control, MAC, Control Element, CE, wherein the MAC CE comprises information identifying a spatial relation between a downlink reference signal that is to be received by the wireless device, and an uplink sounding reference signal that is to be transmitted by the wireless device, wherein the MAC CE has a first length if the MAC CE contains a spatial relation configuration, and wherein the MAC CE has a second length different from the first length if the MAC CE contains an identifier of a preconfigured spatial relation.

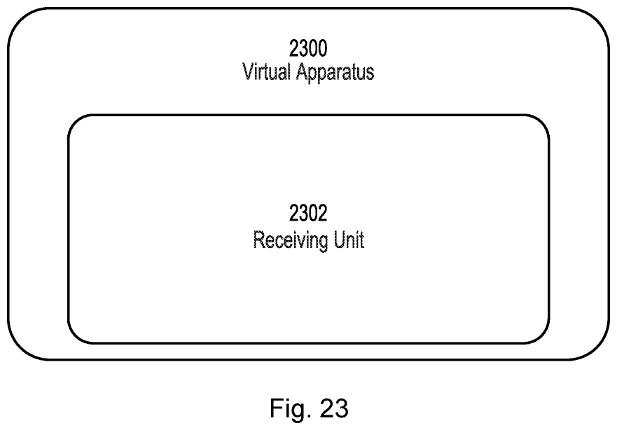

FIG. 23 illustrates a virtualization apparatus in accordance with some embodiments

FIG. 23 illustrates a schematic block diagram of an apparatus WW30 in a wireless network (for example, the wireless network shown in FIG. 9). The apparatus may be implemented in a wireless device or network node (e.g., wireless device 910 or network node 960 shown in FIG. 9). Apparatus 2300 is operable to carry out the example method described with reference to FIG. 22 and possibly any other processes or methods disclosed herein. It is also to be understood that the method of FIG. 22 is not necessarily carried out solely by apparatus 2300. At least some operations of the method can be performed by one or more other entities.

Virtual Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2302 and any other suitable units of apparatus 2300 to perform corresponding functions according one or more embodiments of the present disclosure.

As illustrated in FIG. 23, apparatus 2300 includes receiving unit 2302, which is configured to receive a Medium Access Control, MAC, Control Element, CE, wherein the MAC CE comprises information identifying a spatial relation between a positioning reference signal that is to be received by the wireless device, and an uplink sounding reference signal that is to be transmitted by the wireless device, wherein the MAC CE has a first length if the MAC CE contains a spatial relation configuration, and wherein the MAC CE has a second length different from the first length if the MAC CE contains an identifier of a preconfigured spatial relation.

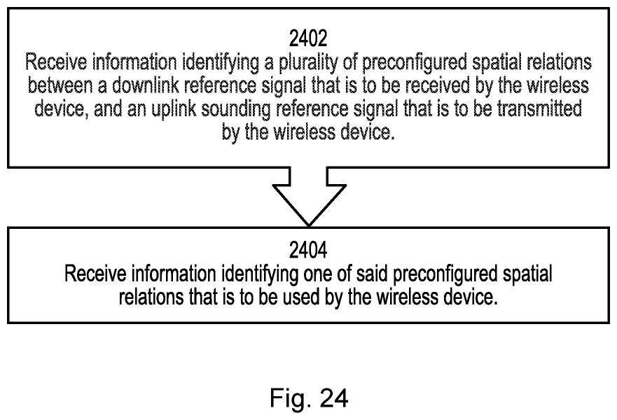

FIG. 24 illustrates a method in accordance with some embodiments.

FIG. 24 depicts a method performed by a wireless device in accordance with particular embodiments. In step 2402, the wireless device receives information identifying a plurality of preconfigured spatial relations between a downlink reference signal that is to be received by the wireless device, and an uplink sounding reference signal that is to be transmitted by the wireless device. In step 2404, the wireless device receives information identifying one of said preconfigured spatial relations that is to be used by the wireless device.

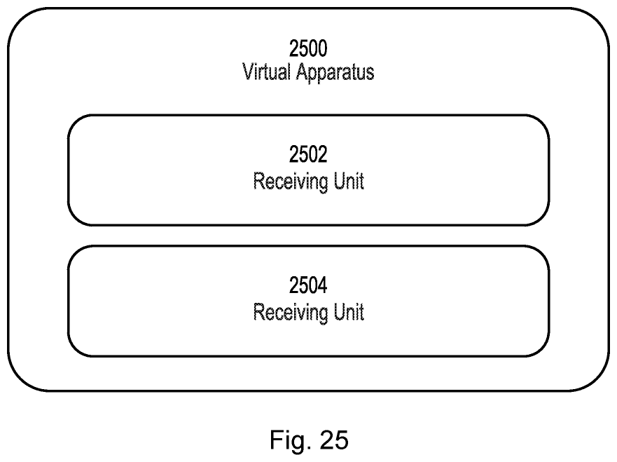

FIG. 25 illustrates a virtualization apparatus in accordance with some embodiments.

FIG. 25 illustrates a schematic block diagram of an apparatus 2500 in a wireless network (for example, the wireless network shown in FIG. 9). The apparatus may be implemented in a wireless device or network node (e.g., wireless device 910 or network node 960 shown in FIG. 9). Apparatus 2500 is operable to carry out the example method described with reference to FIG. 25 and possibly any other processes or methods disclosed herein. It is also to be understood that the method of FIG. 25 is not necessarily carried out solely by apparatus 2500. At least some operations of the method can be performed by one or more other entities.

Virtual Apparatus 2500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiver unit 2502 and second receiver unit 2504, and any other suitable units of apparatus 2500 to perform corresponding functions according one or more embodiments of the present disclosure.

As illustrated in FIG. 25, apparatus 2500 includes first receiver unit 2502 for receiving information identifying a plurality of preconfigured spatial relations between a downlink reference signal that is to be received by the wireless device, and an uplink sounding reference signal that is to be transmitted by the wireless device, and second receiver unit 2504 for receiving information identifying one of said preconfigured spatial relations that is to be used by the wireless device.

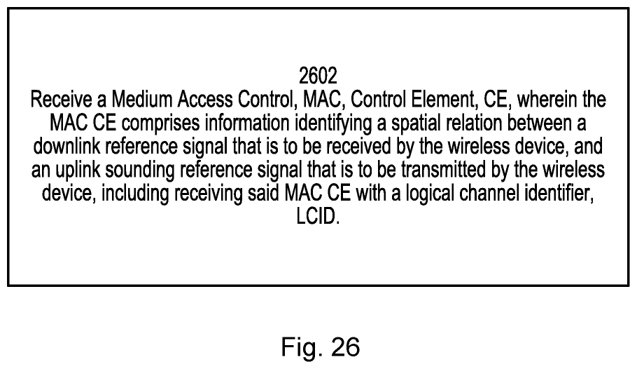

FIG. 26 illustrates a method in accordance with some embodiments.

FIG. 26 depicts a method performed by a wireless device in accordance with particular embodiments, comprising step 2602 of receiving a Medium Access Control, MAC, Control Element, CE, wherein the MAC CE comprises information identifying a spatial relation between a downlink reference signal that is to be received by the wireless device, and an uplink sounding reference signal that is to be transmitted by the wireless device, including receiving said MAC CE with a logical channel identifier, LCID.

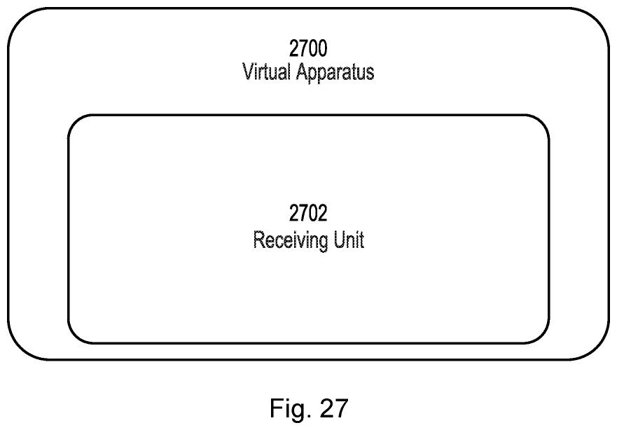

FIG. 27 illustrates a virtualization apparatus in accordance with some embodiments.

FIG. 27 illustrates a schematic block diagram of an apparatus 2700 in a wireless network (for example, the wireless network shown in FIG. 9). The apparatus may be implemented in a wireless device or network node (e.g., wireless device 910 or network node 960 shown in FIG. 9). Apparatus 2700 is operable to carry out the example method described with reference to FIG. 26 and possibly any other processes or methods disclosed herein. It is also to be understood that the method of FIG. 26 is not necessarily carried out solely by apparatus 2700. At least some operations of the method can be performed by one or more other entities.

Virtual Apparatus 2700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 2702 and any other suitable units of apparatus 2700 to perform corresponding functions according one or more embodiments of the present disclosure.

As illustrated in FIG. 27, apparatus 2700 includes receiving unit 2702, which is configured to receive a Medium Access Control, MAC, Control Element, CE, wherein the MAC CE comprises information identifying a spatial relation between a positioning reference signal that is to be received by the wireless device, and an uplink sounding reference signal that is to be transmitted by the wireless device, and wherein said MAC CE is received with a logical channel identifier, LCID.

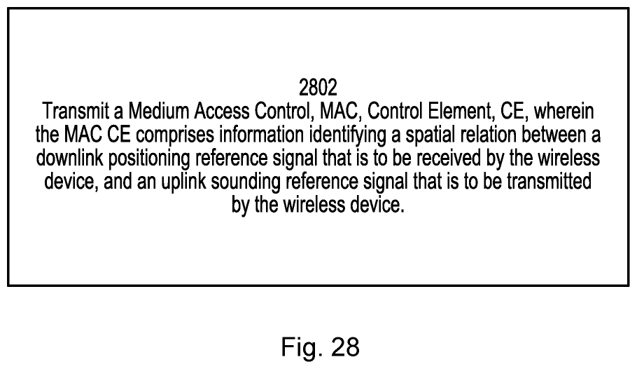

FIG. 28 a method in accordance with some embodiments.

FIG. 28 depicts a method performed by a base station. In accordance with particular embodiments, the method comprises step 2802 of transmitting a Medium Access Control, MAC, Control Element, CE, to a wireless device, wherein the MAC CE comprises information identifying a spatial relation between a downlink positioning reference signal that is to be received by the wireless device, and an uplink sounding reference signal that is to be transmitted by the wireless device.

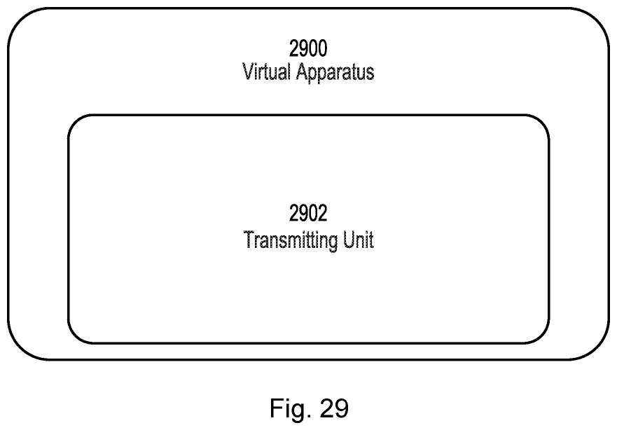

FIG. 29 illustrates a virtualization apparatus in accordance with some embodiments.

FIG. 29 illustrates a schematic block diagram of an apparatus 2900 in a wireless network (for example, the wireless network shown in FIG. 9). The apparatus may be implemented in a wireless device or network node (e.g., wireless device 910 or network node 960 shown in FIG. 9). Apparatus 2900 is operable to carry out the example method described with reference to FIG. 28 and possibly any other processes or methods disclosed herein. It is also to be understood that the method of FIG. 28 is not necessarily carried out solely by apparatus 2900. At least some operations of the method can be performed by one or more other entities.

Virtual Apparatus 2900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 2902 and any other suitable units of apparatus 2900 to perform corresponding functions according one or more embodiments of the present disclosure.

As illustrated in FIG. 29, apparatus 2900 includes transmitting unit 2902, which is configured to transmit a Medium Access Control, MAC, Control Element, CE, to a wireless device, wherein the MAC CE comprises information identifying a spatial relation between a downlink positioning reference signal that is to be received by the wireless device, and an uplink sounding reference signal that is to be transmitted by the wireless device.

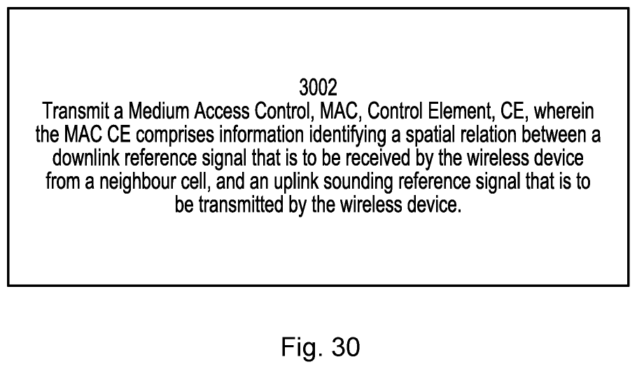

FIG. 30 illustrates a method in accordance with some embodiments.

FIG. 30 depicts a method performed by a base station. In accordance with particular embodiments, the method comprises step 3002 of transmitting a Medium Access Control, MAC, Control Element, CE, to a wireless device, wherein the MAC CE comprises information identifying a spatial relation between a downlink reference signal that is to be received by the wireless device from a neighbour cell, and an uplink sounding reference signal that is to be transmitted by the wireless device.

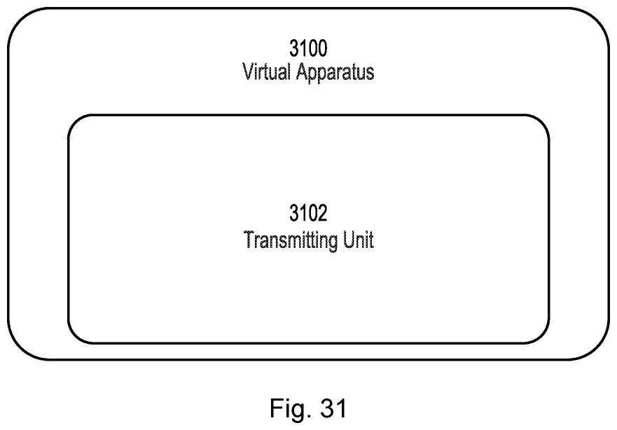

FIG. 31 illustrates a virtualization apparatus in accordance with some embodiments

FIG. 31 illustrates a schematic block diagram of an apparatus 3100 in a wireless network (for example, the wireless network shown in FIG. 9). The apparatus may be implemented in a wireless device or network node (e.g., wireless device 910 or network node 960 shown in FIG. 9). Apparatus 3100 is operable to carry out the example method described with reference to FIG. 30 and possibly any other processes or methods disclosed herein. It is also to be understood that the method of FIG. 30 is not necessarily carried out solely by apparatus 3100. At least some operations of the method can be performed by one or more other entities.

Virtual Apparatus 3100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 3102 and any other suitable units of apparatus 3100 to perform corresponding functions according one or more embodiments of the present disclosure.

As illustrated in FIG. 31, apparatus 3100 includes transmitting unit 3102, which is configured to transmit a Medium Access Control, MAC, Control Element, CE, to a wireless device, wherein the MAC CE comprises information identifying a spatial relation between a positioning reference signal that is to be received by the wireless device from a neighbour cell, and an uplink sounding reference signal that is to be transmitted by the wireless device.

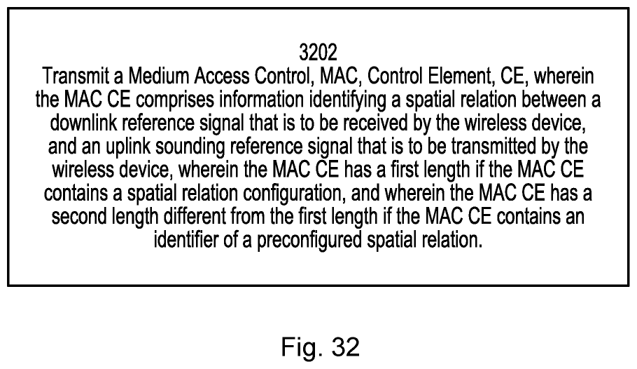

FIG. 32 illustrates a method in accordance with some embodiments

FIG. 32 depicts a method performed by a base station. In accordance with particular embodiments, the method comprises step 3202 of transmitting a Medium Access Control, MAC, Control Element, CE, to a wireless device, wherein the MAC CE comprises information identifying a spatial relation between a downlink reference signal that is to be received by the wireless device, and an uplink sounding reference signal that is to be transmitted by the wireless device, wherein the MAC CE has a first length if the MAC CE contains a spatial relation configuration, and wherein the MAC CE has a second length different from the first length if the MAC CE contains an identifier of a preconfigured spatial relation.

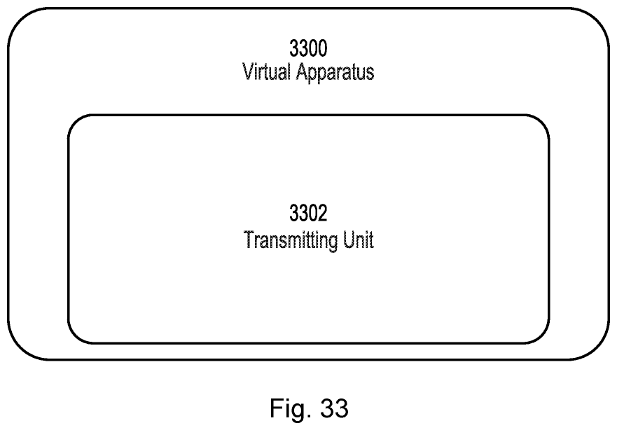

FIG. 33 illustrates a virtualization apparatus in accordance with some embodiments

FIG. 33 illustrates a schematic block diagram of an apparatus 3300 in a wireless network (for example, the wireless network shown in FIG. 9). The apparatus may be implemented in a wireless device or network node (e.g., wireless device 910 or network node 960 shown in FIG. 9). Apparatus 3300 is operable to carry out the example method described with reference to FIG. 32 and possibly any other processes or methods disclosed herein. It is also to be understood that the method of FIG. 32 is not necessarily carried out solely by apparatus 3300. At least some operations of the method can be performed by one or more other entities.

Virtual Apparatus 3300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 3302 and any other suitable units of apparatus 3300 to perform corresponding functions according one or more embodiments of the present disclosure.

As illustrated in FIG. 33, apparatus 3300 includes transmitting unit 3302, which is configured to transmit a Medium Access Control, MAC, Control Element, CE, wherein the MAC CE comprises information identifying a spatial relation between a positioning reference signal that is to be received by the wireless device, and an uplink sounding reference signal that is to be transmitted by the wireless device, wherein the MAC CE has a first length if the MAC CE contains a spatial relation configuration, and wherein the MAC CE has a second length different from the first length if the MAC CE contains an identifier of a preconfigured spatial relation.

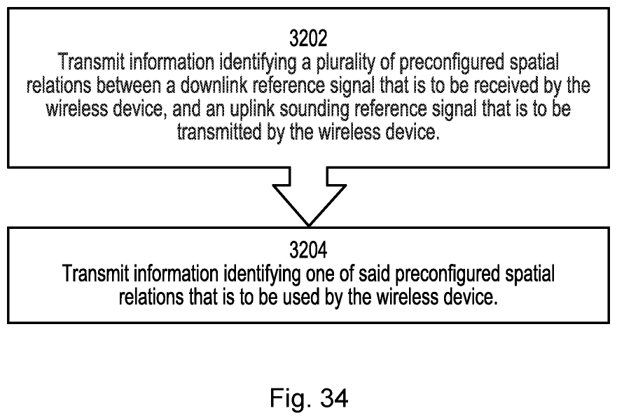

FIG. 34 illustrates a method in accordance with some embodiments.

FIG. 34 depicts a method performed by a base station in accordance with particular embodiments. In step 3402, the base station transmits information identifying a plurality of preconfigured spatial relations between a downlink reference signal that is to be received by a wireless device, and an uplink sounding reference signal that is to be transmitted by the wireless device. In step 3404, the base station transmits information identifying one of said preconfigured spatial relations that is to be used by the wireless device.

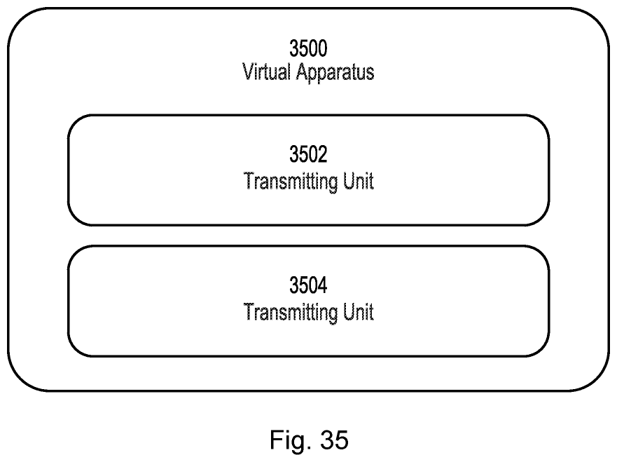

FIG. 35 illustrates a virtualization apparatus in accordance with some embodiments

FIG. 35 illustrates a schematic block diagram of an apparatus 3500 in a wireless network (for example, the wireless network shown in FIG. 9). The apparatus may be implemented in a wireless device or network node (e.g., wireless device 910 or network node 960 shown in FIG. 9). Apparatus 3500 is operable to carry out the example method described with reference to FIG. 34 and possibly any other processes or methods disclosed herein. It is also to be understood that the method of FIG. 34 is not necessarily carried out solely by apparatus 3500. At least some operations of the method can be performed by one or more other entities.

Virtual Apparatus 3500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first transmitting unit 3502 and second transmitting unit 354, and any other suitable units of apparatus 3500 to perform corresponding functions according one or more embodiments of the present disclosure.

As illustrated in FIG. 35, apparatus 3500 includes first transmitting unit 3502 for transmitting information identifying a plurality of preconfigured spatial relations between a downlink reference signal that is to be received by a wireless device, and an uplink sounding reference signal that is to be transmitted by the wireless device, and second transmitting unit 3504 for transmitting information identifying one of said preconfigured spatial relations that is to be used by the wireless device.

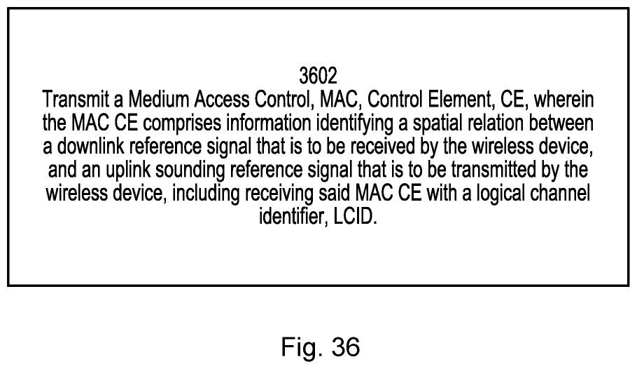

FIG. 36 illustrates a method in accordance with some embodiments

FIG. 36 depicts a method performed by a base station in accordance with particular embodiments, comprising step 3602 of transmitting a Medium Access Control, MAC, Control Element, CE, to a wireless device, wherein the MAC CE comprises information identifying a spatial relation between a downlink reference signal that is to be received by the wireless device, and an uplink sounding reference signal that is to be transmitted by the wireless device, including transmitting said MAC CE with a logical channel identifier, LCID.

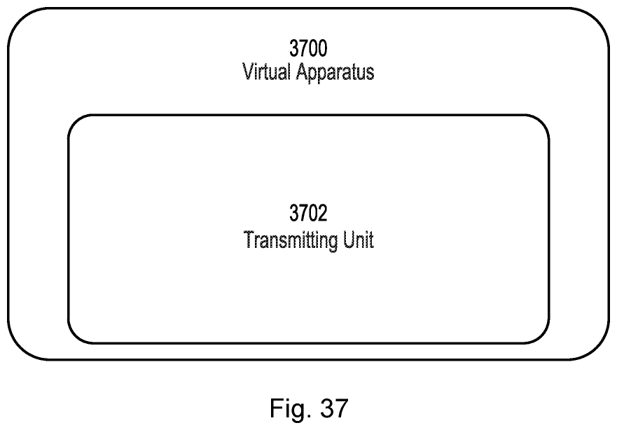

FIG. 37 illustrates a virtualization apparatus in accordance with some embodiments

FIG. 37 illustrates a schematic block diagram of an apparatus 3700 in a wireless network (for example, the wireless network shown in FIG. 9). The apparatus may be implemented in a wireless device or network node (e.g., wireless device 910 or network node 960 shown in FIG. 9). Apparatus 3700 is operable to carry out the example method described with reference to FIG. 36 and possibly any other processes or methods disclosed herein. It is also to be understood that the method of FIG. 36 is not necessarily carried out solely by apparatus 3700. At least some operations of the method can be performed by one or more other entities.

Virtual Apparatus 3700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 3702 and any other suitable units of apparatus 3700 to perform corresponding functions according one or more embodiments of the present disclosure.

As illustrated in FIG. 37, apparatus 3700 includes transmitting unit 3702, which is configured to transmit a Medium Access Control, MAC, Control Element, CE, to a wireless device, wherein the MAC CE comprises information identifying a spatial relation between a positioning reference signal that is to be received by the wireless device, and an uplink sounding reference signal that is to be transmitted by the wireless device, including transmitting said MAC CE with a logical channel identifier, LCID.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Embodiments

### Group A Embodiments

1. A method performed by a wireless device, the method comprising:
   receiving a Medium Access Control, MAC, Control Element, CE, wherein the MAC CE comprises information identifying a spatial relation between a downlink positioning reference signal that is to be received by the wireless device, and an uplink sounding reference signal that is to be transmitted by the wireless device.
2. A method according to embodiment 1, wherein the MAC CE comprises information identifying a spatial relation between a downlink positioning reference signal that is to be received by the wireless device from a neighbor cell, and an uplink sounding reference signal that is to be transmitted by the wireless device.
3. A method according to embodiment 2, wherein the MAC CE comprises information identifying a transmission point, TP, associated with said neighbor cell.
4. A method according to embodiment 1, 2 or 3, wherein the MAC CE has a first length if the MAC CE contains a spatial relation configuration, and wherein the MAC CE has a second length different from the first length if the MAC CE contains an identifier of a preconfigured spatial relation.
5. A method according to one of embodiments 1 to 4, comprising receiving information identifying a plurality of preconfigured spatial relations between a downlink reference signal that is to be received by the wireless device, and an uplink sounding reference signal that is to be transmitted by the wireless device, and wherein the MAC CE comprises information identifying one of said preconfigured spatial relations that is to be used by the wireless device.
6. A method according to one of embodiments 1 to 5, comprising receiving said MAC CE with a logical channel identifier, LCID.
7. A method according to one of embodiments 1 to 6, wherein said MAC CE further comprises an identifier of a cell in which said spatial relation for the sounding reference signal is configured.
8. A method according to one of embodiments 1 to 7, wherein said MAC CE further comprises an identifier of a bandwidth part, BWP.
9. A method according to one of embodiments 1 to 8, wherein said MAC CE further comprises an identifier of a sounding reference signal resource set.
10. A method according to embodiment 9, wherein said MAC CE further comprises information about an assumed spatial relation for resources in said sounding reference signal resource set.
11. A method according to one of embodiments 1 to 10, wherein said MAC CE further comprises information indicating whether additional pairs of sounding reference signal resource identifiers and positioning transmission configuration identifier state identifiers are given.
12. A method according to one of embodiments 1 to 11, further comprising:
   receiving said downlink positioning reference signal; and
   transmitting the uplink sounding reference signal using said information identifying the spatial relation between the downlink positioning reference signal and the uplink sounding reference signal.
13. A method performed by a wireless device, the method comprising:
   receiving a Medium Access Control, MAC, Control Element, CE, wherein the MAC CE comprises information identifying a spatial relation between a downlink reference signal that is to be received by the wireless device from a neighbor cell, and an uplink sounding reference signal that is to be transmitted by the wireless device.
14. A method according to embodiment 13, wherein the MAC CE comprises information identifying a transmission point, TP, associated with said neighbor cell.
15. A method according to embodiment 13 or 14, wherein the downlink reference signal is a downlink positioning reference signal.
16. A method according to embodiment 13, 14 or 15, wherein the MAC CE has a first length if the MAC CE contains a spatial relation configuration, and
   wherein the MAC CE has a second length different from the first length if the MAC CE contains an identifier of a preconfigured spatial relation.
17. A method according to one of embodiments 13 to 16, comprising receiving information identifying a plurality of preconfigured spatial relations between a downlink reference signal that is to be received by the wireless device, and an uplink sounding reference signal that is to be transmitted by the wireless device, and
   wherein the MAC CE comprises information identifying one of said preconfigured spatial relations that is to be used by the wireless device.
18. A method according to one of embodiments 13 to 17, comprising receiving said MAC CE with a logical channel identifier, LCID.
19. A method according to one of embodiments 13 to 18, wherein said MAC CE further comprises an identifier of a cell in which said spatial relation for the sounding reference signal is configured.
20. A method according to one of embodiments 13 to 19, wherein said MAC CE further comprises an identifier of a bandwidth part, BWP.
21. A method according to one of embodiments 13 to 20, wherein said MAC CE further comprises an identifier of a sounding reference signal resource set.
22. A method according to embodiment 21, wherein said MAC CE further comprises information about an assumed spatial relation for resources in said sounding reference signal resource set.
23. A method according to one of embodiments 13 to 22, wherein said MAC CE further comprises information indicating whether additional pairs of sounding reference signal resource identifiers and positioning transmission configuration identifier state identifiers are given.
24. A method according to one of embodiments 13 to 23, further comprising:
   receiving said downlink reference signal; and
   transmitting the uplink sounding reference signal using said information identifying the spatial relation between the downlink reference signal and the uplink sounding reference signal.
25. A method performed by a wireless device, the method comprising:
   receiving a Medium Access Control, MAC, Control Element, CE, wherein the MAC CE comprises information identifying a spatial relation between a downlink reference signal that is to be received by the wireless device, and an uplink sounding reference signal that is to be transmitted by the wireless device,
   wherein the MAC CE has a first length if the MAC CE contains a spatial relation configuration, and
   wherein the MAC CE has a second length different from the first length if the MAC CE contains an identifier of a preconfigured spatial relation.
26. A method according to embodiment 25, wherein said downlink reference signal is a downlink reference signal that is to be received by the wireless device from a neighbor cell.
27. A method according to embodiment 26, wherein the MAC CE comprises information identifying a transmission point, TP, associated with said neighbor cell.
28. A method according to embodiment 25, 26 or 27, wherein the downlink reference signal is a downlink positioning reference signal.
29. A method according to one of embodiments 25 to 28, comprising receiving information identifying a plurality of preconfigured spatial relations between a downlink reference signal that is to be received by the wireless device, and an uplink sounding reference signal that is to be transmitted by the wireless device, and
   wherein the MAC CE comprises information identifying one of said preconfigured spatial relations that is to be used by the wireless device.
30. A method according to one of embodiments 25 to 29, comprising receiving said MAC CE with a logical channel identifier, LCID.
31. A method according to one of embodiments 25 to 30, wherein said MAC CE further comprises an identifier of a cell in which said spatial relation for the sounding reference signal is configured.
32. A method according to one of embodiments 25 to 31, wherein said MAC CE further comprises an identifier of a bandwidth part, BWP.
33. A method according to one of embodiments 25 to 32, wherein said MAC CE further comprises an identifier of a sounding reference signal resource set.
34. A method according to embodiment 33, wherein said MAC CE further comprises information about an assumed spatial relation for resources in said sounding reference signal resource set.
35. A method according to one of embodiments 25 to 34, wherein said MAC CE further comprises information indicating whether additional pairs of sounding reference signal resource identifiers and positioning transmission configuration identifier state identifiers are given.
36. A method according to one of embodiments 25 to 35, further comprising:
   receiving said downlink reference signal; and
   transmitting the uplink sounding reference signal using said information identifying the spatial relation between the downlink reference signal and the uplink sounding reference signal.
37. A method performed by a wireless device, the method comprising:
   receiving information identifying a plurality of preconfigured spatial relations between a downlink reference signal that is to be received by the wireless device, and an uplink sounding reference signal that is to be transmitted by the wireless device, and
   receiving information identifying one of said preconfigured spatial relations that is to be used by the wireless device.
38. A method according to embodiment 37, comprising receiving said information identifying one of said preconfigured spatial relations that is to be used by the wireless device in a Medium Access Control, MAC, Control Element, CE.
39. A method according to embodiment 37 or 38, wherein said information identifying one of said preconfigured spatial relations that is to be used by the wireless device comprises information about a synchronization signal block, SSB, of a serving cell or of a neighbor cell.
40. A method according to embodiment 37, 38 or 39, wherein said information identifying one of said preconfigured spatial relations that is to be used by the wireless device comprises information about a positioning reference signal, PRS, of a serving cell or of a neighbor cell.
41. A method according to one of embodiments 37 to 40, wherein said information identifying one of said preconfigured spatial relations that is to be used by the wireless device comprises information about a channel state information reference signal, CSI-RS, of a serving cell or of a neighbor cell.
42. A method according to one of embodiments 37 to 41, wherein said information identifying one of said preconfigured spatial relations that is to be used by the wireless device comprises information about a sounding reference signal, SRS.
43. A method according to one of embodiments 37 to 42, comprising receiving said information identifying the plurality of preconfigured spatial relations between a downlink reference signal and an uplink sounding reference signal in radio resource control RRC, configuration.
44. A method according to one of embodiments 37 to 42, comprising receiving said information identifying the plurality of preconfigured spatial relations between a downlink reference signal and an uplink sounding reference signal in an LTE positioning protocol, LPP, message.
45. A method according to one of embodiments 37 to 44, further comprising:
   receiving said downlink reference signal; and
   transmitting the uplink sounding reference signal using said information identifying the spatial relation between the downlink reference signal and the uplink sounding reference signal.
46. A method performed by a wireless device, the method comprising:
   receiving information identifying a spatial relation between a downlink reference signal that is to be received by the wireless device, and an uplink sounding reference signal that is to be transmitted by the wireless device, and further comprising:
   receiving information identifying a transmission and reception point, TRP, identifier or a Cell identifier, based upon the downlink reference signal that is to be received by the wireless device.
47. A method according to embodiment 46, further comprising:
   receiving said downlink reference signal; and
   transmitting the uplink sounding reference signal using said information identifying the spatial relation between the downlink reference signal and the uplink sounding reference signal.
48. A method performed by a wireless device, the method comprising:
   receiving information identifying a spatial relation between a downlink reference signal that is to be received by the wireless device, and an uplink sounding reference signal that is to be transmitted by the wireless device, and further comprising:
   receiving information identifying a synchronization signal block, SSB, index or a sounding reference signal, SRS, bandwidth part, BWP, and/or a SRS Resource set based upon the downlink reference signal that is to be received by the wireless device.
49. A method according to embodiment 48, further comprising:
   receiving said downlink reference signal; and
   transmitting the uplink sounding reference signal using said information identifying the spatial relation between the downlink reference signal and the uplink sounding reference signal.
50. A method performed by a wireless device, the method comprising:
   receiving a Medium Access Control, MAC, Control Element, CE, wherein the MAC CE comprises information identifying a spatial relation between a downlink reference signal that is to be received by the wireless device, and an uplink sounding reference signal that is to be transmitted by the wireless device, and comprising:
   receiving said MAC CE with a logical channel identifier, LCID.
51. A method according to embodiment 50, wherein the MAC CE comprises information identifying a spatial relation between a downlink positioning reference signal that is to be received by the wireless device from a neighbor cell, and an uplink sounding reference signal that is to be transmitted by the wireless device.
52. A method according to embodiment 51, wherein the MAC CE comprises information identifying a transmission point, TP, associated with said neighbor cell.
53. A method according to embodiment 50, 51 or 52, wherein the MAC CE has a first length if the MAC CE contains a spatial relation configuration, and
   wherein the MAC CE has a second length different from the first length if the MAC CE contains an identifier of a preconfigured spatial relation.
54. A method according to one of embodiments 50 to 53, comprising receiving information identifying a plurality of preconfigured spatial relations between a downlink reference signal that is to be received by the wireless device, and an uplink sounding reference signal that is to be transmitted by the wireless device, and
   wherein the MAC CE comprises information identifying one of said preconfigured spatial relations that is to be used by the wireless device.
55. A method according to one of embodiments 50 to 54, wherein said MAC CE further comprises an identifier of a cell in which said spatial relation for the sounding reference signal is configured.
56. A method according to one of embodiments 50 to 55, wherein said MAC CE further comprises an identifier of a bandwidth part, BWP.
57. A method according to one of embodiments 50 to 56, wherein said MAC CE further comprises an identifier of a sounding reference signal resource set.
58. A method according to embodiment 57, wherein said MAC CE further comprises information about an assumed spatial relation for resources in said sounding reference signal resource set.
59. A method according to one of embodiments 50 to 58, wherein said MAC CE further comprises information indicating whether additional pairs of sounding reference signal resource identifiers and positioning transmission configuration identifier state identifiers are given.
60. A method according to one of embodiments 50 to 59, further comprising:
   receiving said downlink reference signal; and
   transmitting the uplink sounding reference signal using said information identifying the spatial relation between the downlink reference signal and the uplink sounding reference signal.
61. The method of any of the previous embodiments, further comprising:
   providing user data; and
   forwarding the user data to a host computer via the transmission to the base station.

### Group B Embodiments

62. A method performed by a base station for configuring a wireless device, the method comprising:
   transmitting a Medium Access Control, MAC, Control Element, CE, wherein the MAC CE comprises information identifying a spatial relation between a downlink positioning reference signal that is to be received by the wireless device, and an uplink sounding reference signal that is to be transmitted by the wireless device.
63. A method according to embodiment 62, wherein the MAC CE comprises information identifying a spatial relation between a downlink positioning reference signal that is to be received by the wireless device from a neighbor cell, and an uplink sounding reference signal that is to be transmitted by the wireless device.
64. A method according to embodiment 63, wherein the MAC CE comprises information identifying a transmission point, TP, associated with said neighbor cell.
65. A method according to embodiment 62, 63 or 64, wherein the MAC CE has a first length if the MAC CE contains a spatial relation configuration, and
   wherein the MAC CE has a second length different from the first length if the MAC CE contains an identifier of a preconfigured spatial relation.
66. A method according to one of embodiments 62 to 65, wherein the wireless device is preconfigured with information identifying a plurality of spatial relations between a downlink reference signal that is to be received by the wireless device, and an uplink sounding reference signal that is to be transmitted by the wireless device, and
   wherein the MAC CE comprises information identifying one of said preconfigured spatial relations that is to be used by the wireless device.
67. A method according to one of embodiments 62 to 66, comprising transmitting said MAC CE with a logical channel identifier, LCID.
68. A method according to one of embodiments 62 to 67, wherein said MAC CE further comprises an identifier of a cell in which said spatial relation for the sounding reference signal is configured.
69. A method according to one of embodiments 62 to 68, wherein said MAC CE further comprises an identifier of a bandwidth part, BWP.
70. A method according to one of embodiments 62 to 69, wherein said MAC CE further comprises an identifier of a sounding reference signal resource set.
71. A method according to embodiment 70, wherein said MAC CE further comprises information about an assumed spatial relation for resources in said sounding reference signal resource set.
72. A method according to one of embodiments 62 to 71, wherein said MAC CE further comprises information indicating whether additional pairs of sounding reference signal resource identifiers and positioning transmission configuration identifier state identifiers are given.
73. A method according to one of embodiments 62 to 72, further comprising:
   transmitting said downlink positioning reference signal.
74. A method performed by a base station for configuring a wireless device, the method comprising:
   transmitting a Medium Access Control, MAC, Control Element, CE, wherein the MAC CE comprises information identifying a spatial relation between a downlink reference signal that is to be received by the wireless device from a neighbor cell, and an uplink sounding reference signal that is to be transmitted by the wireless device.
75. A method according to embodiment 74, wherein the MAC CE comprises information identifying a transmission point, TP, associated with said neighbor cell.
76. A method according to embodiment 74 or 75, wherein the downlink reference signal is a downlink positioning reference signal.
77. A method according to embodiment 74, 75 or 76, wherein the MAC CE has a first length if the MAC CE contains a spatial relation configuration, and
   wherein the MAC CE has a second length different from the first length if the MAC CE contains an identifier of a preconfigured spatial relation.
78. A method according to one of embodiments 74 to 77, wherein the wireless device is preconfigured with a plurality of spatial relations between a downlink reference signal that is to be received by the wireless device, and an uplink sounding reference signal that is to be transmitted by the wireless device, and
   wherein the MAC CE comprises information identifying one of said preconfigured spatial relations that is to be used by the wireless device.
79. A method according to one of embodiments 74 to 78, comprising transmitting said MAC CE with a logical channel identifier, LCID.
80. A method according to one of embodiments 74 to 79, wherein said MAC CE further comprises an identifier of a cell in which said spatial relation for the sounding reference signal is configured.
81. A method according to one of embodiments 74 to 80, wherein said MAC CE further comprises an identifier of a bandwidth part, BWP.
82. A method according to one of embodiments 74 to 81, wherein said MAC CE further comprises an identifier of a sounding reference signal resource set.
83. A method according to embodiment 82, wherein said MAC CE further comprises information about an assumed spatial relation for resources in said sounding reference signal resource set.
84. A method according to one of embodiments 74 to 83, wherein said MAC CE further comprises information indicating whether additional pairs of sounding reference signal resource identifiers and positioning transmission configuration identifier state identifiers are given.
85. A method performed by a base station for configuring a wireless device, the method comprising:
   transmitting a Medium Access Control, MAC, Control Element, CE, wherein the MAC CE comprises information identifying a spatial relation between a downlink reference signal that is to be received by the wireless device, and an uplink sounding reference signal that is to be transmitted by the wireless device, wherein the MAC CE has a first length if the MAC CE contains a spatial relation configuration, and
   wherein the MAC CE has a second length different from the first length if the MAC CE contains an identifier of a preconfigured spatial relation.
86. A method according to embodiment 85, wherein said downlink reference signal is a downlink reference signal that is to be received by the wireless device from a neighbor cell.
87. A method according to embodiment 86, wherein the MAC CE comprises information identifying a transmission point, TP, associated with said neighbor cell.
88. A method according to embodiment 85, 86 or 87, wherein the downlink reference signal is a downlink positioning reference signal.
89. A method according to one of embodiments 85 to 88, wherein the wireless device is preconfigured with a plurality of spatial relations between a downlink reference signal that is to be received by the wireless device, and an uplink sounding reference signal that is to be transmitted by the wireless device, and
   wherein the MAC CE comprises information identifying one of said preconfigured spatial relations that is to be used by the wireless device.
90. A method according to one of embodiments 85 to 89, comprising transmitting said MAC CE with a logical channel identifier, LCID.
91. A method according to one of embodiments 85 to 90, wherein said MAC CE further comprises an identifier of a cell in which said spatial relation for the sounding reference signal is configured.
92. A method according to one of embodiments 85 to 91, wherein said MAC CE further comprises an identifier of a bandwidth part, BWP.
93. A method according to one of embodiments 85 to 92, wherein said MAC CE further comprises an identifier of a sounding reference signal resource set.
94. A method according to embodiment 93, wherein said MAC CE further comprises information about an assumed spatial relation for resources in said sounding reference signal resource set.
95. A method according to one of embodiments 85 to 94, wherein said MAC CE further comprises information indicating whether additional pairs of sounding reference signal resource identifiers and positioning transmission configuration identifier state identifiers are given.
96. A method according to one of embodiments 85 to 95, further comprising:
   transmitting said downlink reference signal.
97. A method performed by a base station for configuring a wireless device, the method comprising:
   transmitting information identifying a plurality of preconfigured spatial relations between a downlink reference signal that is to be received by the wireless device, and an uplink sounding reference signal that is to be transmitted by the wireless device, and
   transmitting information identifying one of said preconfigured spatial relations that is to be used by the wireless device.
98. A method according to embodiment 97, comprising transmitting said information identifying one of said preconfigured spatial relations that is to be used by the wireless device in a Medium Access Control, MAC, Control Element, CE.
99. A method according to embodiment 97 or 98, wherein said information identifying one of said preconfigured spatial relations that is to be used by the wireless device comprises information about a synchronization signal block, SSB, of a serving cell or of a neighbor cell.
100.A method according to embodiment 97, 98 or 99, wherein said information identifying one of said preconfigured spatial relations that is to be used by the wireless device comprises information about a positioning reference signal, PRS, of a serving cell or of a neighbor cell.
101.A method according to one of embodiments 97 to 100, wherein said information identifying one of said preconfigured spatial relations that is to be used by the wireless device comprises information about a channel state information reference signal, CSI-RS, of a serving cell or of a neighbor cell.
102.A method according to one of embodiments 97 to 101, wherein said information identifying one of said preconfigured spatial relations that is to be used by the wireless device comprises information about a sounding reference signal, SRS.
103.A method according to one of embodiments 97 to 102, comprising transmitting said information identifying the plurality of preconfigured spatial relations between a downlink reference signal and an uplink sounding reference signal in radio resource control RRC, configuration.
104.A method according to one of embodiments 97 to 102, comprising transmitting said information identifying the plurality of preconfigured spatial relations between a downlink reference signal and an uplink sounding reference signal in an LTE positioning protocol, LPP, message.
105.A method according to one of embodiments 97 to 104, further comprising:
   transmitting said downlink reference signal.
106.A method performed by a base station for configuring a wireless device, the method comprising:
   transmitting information identifying a spatial relation between a downlink reference signal that is to be received by the wireless device, and an uplink sounding reference signal that is to be transmitted by the wireless device, and further comprising:
   transmitting information identifying a transmission and reception point, TRP, identifier or a Cell identifier, based upon the downlink reference signal that is to be received by the wireless device.
107.A method according to embodiment 106, further comprising:
   transmitting said downlink reference signal.
108.A method performed by a base station for configuring a wireless device, the method comprising:
   transmitting information identifying a spatial relation between a downlink reference signal that is to be received by the wireless device, and an uplink sounding reference signal that is to be transmitted by the wireless device, and further comprising:
   transmitting information identifying a synchronization signal block, SSB, index or a sounding reference signal, SRS, bandwidth part, BWP, and/or a SRS Resource set based upon the downlink reference signal that is to be received by the wireless device.
109.A method according to embodiment 108, further comprising:
   transmitting said downlink reference signal.
110.A method performed by a base station for configuring a wireless device, the method comprising:
   transmitting a Medium Access Control, MAC, Control Element, CE, wherein the MAC CE comprises information identifying a spatial relation between a downlink reference signal that is to be received by the wireless device, and an uplink sounding reference signal that is to be transmitted by the wireless device, and comprising:
   transmitting said MAC CE with a logical channel identifier, LCID.
111.A method according to embodiment 110, wherein the MAC CE comprises information identifying a spatial relation between a downlink positioning reference signal that is to be received by the wireless device from a neighbor cell, and an uplink sounding reference signal that is to be transmitted by the wireless device.
112.A method according to embodiment 111, wherein the MAC CE comprises information identifying a transmission point, TP, associated with said neighbor cell.
113.A method according to embodiment 110, 111 or 112, wherein the MAC CE has a first length if the MAC CE contains a spatial relation configuration, and
   wherein the MAC CE has a second length different from the first length if the MAC CE contains an identifier of a preconfigured spatial relation.
114.A method according to one of embodiments 110 to 113, wherein the wireless device is preconfigured with a plurality of spatial relations between a downlink reference signal that is to be received by the wireless device, and an uplink sounding reference signal that is to be transmitted by the wireless device, and
   wherein the MAC CE comprises information identifying one of said preconfigured spatial relations that is to be used by the wireless device.
115.A method according to one of embodiments 110 to 114, wherein said MAC CE further comprises an identifier of a cell in which said spatial relation for the sounding reference signal is configured.
116.A method according to one of embodiments 110 to 115, wherein said MAC CE further comprises an identifier of a bandwidth part, BWP.
117.A method according to one of embodiments 110 to 116, wherein said MAC CE further comprises an identifier of a sounding reference signal resource set.
118.A method according to embodiment 117, wherein said MAC CE further comprises information about an assumed spatial relation for resources in said sounding reference signal resource set.
119.A method according to one of embodiments 110 to 118, wherein said MAC CE further comprises information indicating whether additional pairs of sounding reference signal resource identifiers and positioning transmission configuration identifier state identifiers are given.
120.A method according to one of embodiments 110 to 119, further comprising:
   transmitting said downlink reference signal.
121. The method of any of the previous Group B embodiments, further comprising:
   obtaining user data; and
   forwarding the user data to a host computer or a wireless device.

### Group C Embodiments

122.A wireless device comprising:
   processing circuitry configured to perform any of the steps of any of the Group A embodiments; and
   power supply circuitry configured to supply power to the wireless device.
123.A base station comprising:
   processing circuitry configured to perform any of the steps of any of the Group B embodiments;
   power supply circuitry configured to supply power to the base station.
124.A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
125.A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
126. The communication system of the previous embodiment further including the base station.
127. The communication system of the previous 2 embodiments, further including the UE, wherein the UE is configured to communicate with the base station.
128. The communication system of the previous 3 embodiments, wherein:
   the processing circuitry of the host computer is configured to execute a host application, thereby providing the user data; and
   the UE comprises processing circuitry configured to execute a client application associated with the host application.
129.A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
130. The method of the previous embodiment, further comprising, at the base station, transmitting the user data.
131. The method of the previous 2 embodiments, wherein the user data is provided at the host computer by executing a host application, the method further comprising, at the UE, executing a client application associated with the host application.
132.A user equipment (UE) configured to communicate with a base station, the UE comprising a radio interface and processing circuitry configured to performs the of the previous 3 embodiments.
133.A communication system including a host computer comprising:
   processing circuitry configured to provide user data; and a communication interface configured to forward user data to a cellular network for transmission to a user equipment (UE),
   wherein the UE comprises a radio interface and processing circuitry, the UE's components configured to perform any of the steps of any of the Group A embodiments.
134. The communication system of the previous embodiment, wherein the cellular network further includes a base station configured to communicate with the UE.
135. The communication system of the previous 2 embodiments, wherein:
   the processing circuitry of the host computer is configured to execute a host application, thereby providing the user data; and
   the UE's processing circuitry is configured to execute a client application associated with the host application.
136.A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
137. The method of the previous embodiment, further comprising at the UE, receiving the user data from the base station.
138.A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
139. The communication system of the previous embodiment, further including the UE.
140. The communication system of the previous 2 embodiments, further including the base station, wherein the base station comprises a radio interface configured to communicate with the UE and a communication interface configured to forward to the host computer the user data carried by a transmission from the UE to the base station.
141. The communication system of the previous 3 embodiments, wherein:
   the processing circuitry of the host computer is configured to execute a host application; and
   the UE's processing circuitry is configured to execute a client application associated with the host application, thereby providing the user data.
142. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
143.A method implemented in a communication system including a host computer, a base station and a user equipment (UE), the method comprising:
   at the host computer, receiving user data transmitted to the base station from the UE, wherein the UE performs any of the steps of any of the Group A embodiments.
144. The method of the previous embodiment, further comprising, at the UE, providing the user data to the base station.
145. The method of the previous 2 embodiments, further comprising:
   at the UE, executing a client application, thereby providing the user data to be transmitted; and
   at the host computer, executing a host application associated with the client application.
146. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
147.A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
148. The communication system of the previous embodiment further including the base station.
149. The communication system of the previous 2 embodiments, further including the UE, wherein the UE is configured to communicate with the base station.
150. The communication system of the previous 3 embodiments, wherein:
   the processing circuitry of the host computer is configured to execute a host application;
   the UE is configured to execute a client application associated with the host application, thereby providing the user data to be received by the host computer.
151.A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
152. The method of the previous embodiment, further comprising at the base station, receiving the user data from the UE.
153. The method of the previous 2 embodiments, further comprising at the base station, initiating a transmission of the received user data to the host computer.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1-28. (canceled)

29. A method performed by a wireless device, the method comprising:
receiving a Medium Access Control (MAC) Control Element (CE), wherein the MAC CE comprises information identifying a spatial relation for positioning between a downlink reference signal that is to be received by the wireless device, and an uplink sounding reference signal (SRS) that is to be transmitted by the wireless device.

30. The method of claim 29, wherein the MAC CE comprises information identifying a spatial relation between the downlink reference signal that is to be received by the wireless device from a neighbor cell, and the uplink sounding reference signal that is to be transmitted by the wireless device.

31. The method of claim 30, wherein the MAC CE comprises information identifying a spatial relation which includes information about the downlink reference signal, wherein the downlink signal comprises one of: a synchronization signal block (SSB), a downlink positioning reference signal, DL-PRS, a sounding reference signal (SRS) and a channel state information reference signal (CSI-RS).

32. The method of claim 31, wherein the MAC CE comprises information identifying a positioning spatial relation which includes 1 bit to indicate positioning SRS resource index.

33. The method of claim 29, wherein the MAC CE wherein the downlink reference signal comprises a downlink positioning reference signal DL-PRS, and wherein the MAC CE comprises one or more of: an indication of a transmission and reception point identifier (TRP ID), a Resource Set, and a resource ID.

34. The method of claim 29, wherein the downlink reference signal comprises a synchronization signal block (SSB) and wherein the MAC CE comprises one or more of: an SSB Index and a Cell ID.

35. The method of claim 29, wherein the downlink reference signal comprises a sounding reference signal (SRS) and wherein the MAC CE comprises one or more of: an SRS Resource ID, a Cell ID and a bandwidth part identification, BWP ID.

36. The method of claim 29, wherein the downlink reference signal comprises a channel state information reference signal, CSI-RS, and wherein the MAC CE comprises one or more of: a Cell ID and an CSI-RS resource ID.

37. The method of claim 29, comprising receiving information identifying a plurality of preconfigured spatial relations between a downlink reference signal that is to be received by the wireless device, and an uplink sounding reference signal that is to be transmitted by the wireless device, and
wherein the MAC CE comprises information identifying one of said preconfigured spatial relations that is to be used by the wireless device.

38. The method of claim 29, further comprising:
receiving said downlink positioning reference signal; and
transmitting the uplink sounding reference signal using said information identifying the spatial relation between the downlink positioning reference signal and the uplink sounding reference signal.

39. A method performed by base station for configuring a wireless device, the method comprising:
transmitting a Medium Access Control (MAC) Control Element, CE, to the wireless device, wherein the MAC CE comprises information identifying a spatial relation for positioning between a downlink reference signal that is to be received by the wireless device, and an uplink sounding reference signal (SRS) that is to be transmitted by the wireless device.

40. The method of claim 39, wherein the MAC CE comprises information identifying a spatial relation between the downlink reference signal that is to be received by the wireless device from a neighbor cell, and the uplink sounding reference signal that is to be transmitted by the wireless device.

41. The method of claim 40, wherein the MAC CE comprises information identifying a spatial relation which includes information about the downlink reference signal, wherein the downlink signal comprises one of: a synchronization signal block (SSB), a downlink positioning reference signal (DL-PRS), a sounding reference signal (SRS), and a channel state information reference signal (CSI-RS).

42. The method of claim 41, wherein the MAC CE comprises information identifying a positioning spatial relation which includes 1 bit to indicate positioning SRS resource index.

43. The method of claim 39, wherein the downlink reference signal comprises a sounding reference signal (SRS) and wherein the MAC CE comprises one or more of: an SRS Resource ID, a Cell ID and a bandwidth part identification, BWP ID.

44. The method of claim 39, wherein the downlink reference signal comprises a channel state information reference signal (CSI-RS) and wherein the MAC CE comprises one or more of: a Cell ID and an CSI-RS resource ID.

45. The method of claim 39, comprising transmitting information identifying a plurality of preconfigured spatial relations between a downlink reference signal that is to be received by the wireless device, and an uplink sounding reference signal that is to be transmitted by the wireless device, and
wherein the MAC CE comprises information identifying one of said preconfigured spatial relations that is to be used by the wireless device.

46. The method of claim 39, further comprising:
transmitting said downlink positioning reference signal; and
receiving the uplink sounding reference signal using said information identifying the spatial relation between the downlink positioning reference signal and the uplink sounding reference signal.

47. A wireless device, wherein the wireless device comprises processing circuitry configured to perform the method as claimed in claim 29.

48. A base station, wherein the base station comprises processing circuitry configured to perform the method as claimed in claim 39.
